(19) United States
(12) Patent Application Publication
(10) Pub. No.: US 2016/0187629 A1
(43) Pub. Date: Jun. 30, 2016

(54) ZOOM LENS

(71) Applicant: TAMRON CO., LTD., Saitama-shi (JP)

(72) Inventor: Hirofumi TABATA, Saitama-shi (JP)

(73) Assignee: TAMRON CO., LTD., Saitama-shi (JP)

(21) Appl. No.: 14/830,903

(22) Filed: Aug. 20, 2015

(30) Foreign Application Priority Data
Dec. 26, 2014 (JP) 2014-265327

(51) Int. Cl. G02B 15/177; G02B 13/18; G02B 15/20; G02B 27/00; G02B 5/00

(52) U.S. Cl. CPC G02B 15/177; G02B 27/0068; G02B 5/005; G02B 15/20; G02B 13/18

(57) ABSTRACT

A zoom lens includes sequentially from an object side, a first lens group having a negative refractive power; a second lens group having a positive refractive power; and a third lens group. The zoom lens performs zooming by varying intervals of the first, the second, and the third lens groups, on an optical axis. The second lens group is configured to include sequentially from the object side, a positive lens, a negative lens, and a positive lens. The third lens group is configured to include a negative lens farthest on the object side. The zoom lens satisfies a condition expression (1) 2.8≦|β2T/β2W|≦12.0, where β2T represents magnification of the second lens group at a telephoto edge, and β2W represents magnification of the second lens group at a wide angle edge.

### BACKGROUND OF THE INVENTION

1. Field of the Invention

The present invention relates to a zoom lens.

2. Description of the Related Art

Imaging apparatuses such as single lens reflex cameras, digital still cameras, video cameras, and surveillance cameras, equipped with a solid-state image sensing device such as a CCD or COMS have spread rapidly. With this spread, a multitude of zoom lenses that can be used on such imaging apparatuses equipped with a solid-state image sensing device such as a CCD or CMOS have been proposed (for example, refer to Japanese Patent Application Laid-Open Publication Nos. 2012-22080 and 2012-168513, and Japanese Patent No. 4283553).

Recently, with advances in higher pixel densities and higher sensitivities of solid-state image sensing devices, higher optical performance is also demanded of imaging lenses. Further, with reductions in the size of imaging apparatuses, reductions in the size and weight of imaging lenses are desirable. Zoom lenses with a high zoom ratio for light in the visible light region to the near infrared region and enabling various uses such as on surveillance cameras and vehicle-equipped cameras are also demanded.

Zoom lenses recited in Japanese Patent Application Laid-Open Publication Nos. 2012-22080 and 2012-168513 are zoom lenses having a simple lens group configuration in which lens groups respectively having negative, positive, and positive refractive powers are arranged sequentially from the object side. Nonetheless, with these zoom lenses, lens counts of the first lens group and the third lens group are low, making the suppression of various types of aberration occurring at the lens groups difficult and consequently, favorable imaging cannot be obtained. This problem becomes more conspicuous the higher the zoom ratio of an image is. Further, a problem arises in that with respect to near infrared light, chromatic difference of aberration and longitudinal chromatic aberration occurring at the telephoto edge become conspicuous, making optical performance for near infrared light drop significantly.

The zoom lens recited in Japanese Patent No. 4283553 has a high zoom ratio and corrects aberration with respect to light from the visible light region to the near infrared region. However, since the first lens group has a positive refractive power, attempts to increase the aperture ratio tend to increase the overall size of the optical system, making it difficult to achieve both a large aperture ratio and reduction in size.

### SUMMARY OF THE INVENTION

It is an object of the present invention to at least solve the above problems in the conventional technologies.

A zoom lens includes sequentially from an object side, a first lens group having a negative refractive power; a second lens group having a positive refractive power; and a third lens group. The zoom lens performs zooming by varying intervals of the first, the second, and the third lens groups, on an optical axis. The second lens group is configured to include sequentially from the object side, a positive lens, a negative lens, and a positive lens. The third lens group is configured to include a negative lens farthest on the object side. The zoom lens satisfies a condition expression (1) 2.8≦|β2T/β2W|≦12.0, where β2T represents magnification of the second lens group at a telephoto edge, and β2W represents magnification of the second lens group at a wide angle edge.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a diagram depicting, along an optical axis, a configuration of the zoom lens according to a first embodiment;

FIG. 2 is a diagram of various types of aberration occurring in the zoom lens according to the first embodiment;

FIG. 3 is a diagram depicting, along the optical axis, a configuration of the zoom lens according to a second embodiment;

FIG. 4 is a diagram of various types of aberration occurring in the zoom lens according to the second embodiment;

FIG. 5 is a diagram depicting, along the optical axis, a configuration of the zoom lens according to a third embodiment;

FIG. 6 is a diagram of various types of aberration occurring in the zoom lens according to the third embodiment;

FIG. 7 is a diagram depicting, along the optical axis, a configuration of the zoom lens according to a fourth embodiment;

FIG. 8 is a diagram of various types of aberration occurring in the zoom lens according to the fourth embodiment;

FIG. 9 is a diagram depicting, along the optical axis, a configuration of the zoom lens according to a fifth embodiment;

FIG. 10 is a diagram of various types of aberration occurring in the zoom lens according to the fifth embodiment;

FIG. 11 is a diagram depicting, along the optical axis, a configuration of the zoom lens according to a sixth embodiment;

FIG. 12 is a diagram of various types of aberration occurring in the zoom lens according to the sixth embodiment;

FIG. 13 is a diagram depicting, along the optical axis, a configuration of the zoom lens according to a seventh embodiment; and

FIG. 14 is a diagram of various types of aberration occurring in the zoom lens according to the seventh embodiment.

### DETAILED DESCRIPTION OF THE PREFERRED EMBODIMENTS

Preferred embodiments of a zoom lens according to the present invention will be described in detail with reference to the accompanying drawings.

The zoom lens according to the present invention is configured to include sequentially from an object side, a first lens group having a negative refractive power, a second lens group having a positive refractive power, and a third lens group. Zooming is performed by varying intervals of the lens groups, on the optical axis.

To achieve an object, the following conditions are set.

Increasing the refractive power of the lens group responsible for zooming and decreasing the distance that the lens group is moved accompanying zooming is desirable in realizing a zoom lens that is compact and has high optical performance. However, when the refractive power is increased, the amount of aberration that occurs also tends to increase, making it difficult to maintain high optical performance. Therefore, to realize a zoom lens that is compact and has high optical performance, the lens configuration of the lens group responsible for zooming and the magnification of the lens groups at the wide angle edge and the telephoto edge have to be properly set.

In the zoom lens according to the present invention, the second lens group is configured to include sequentially from the object side, a positive lens, a negative lens, and a positive lens. In the second lens group, spherical aberration, field curvature, and chromatic difference of magnification occurring at the positive lens disposed farthest on the object side is corrected by the subsequent negative lens and positive lens. Further, in the second lens group, by disposing a positive lens farthest on the object side, incident light rays can be converged by the positive lens, enabling diameter reductions of the second lens group and lens groups thereafter.

The third lens group is configured to include a negative lens farthest on the object side. The negative lens diffuses light beams incident near the optical axis, enabling favorable correction of the field curvature at the telephoto edge.

The zoom lens according to the present invention, with the above configuration, preferably satisfies the following conditional expression, where β2T is the magnification of the second lens group at the telephoto edge and β2W is the magnification of the second lens group at the wide angle edge.

2.8≦|β2T/β2W|≦12.0 (1)

Conditional expression (1) prescribes a ratio of the magnification of the second lens group at the telephoto edge and the magnification thereof at the wide angle edge. Satisfying conditional expression (1) facilitates reductions in the size of the optical system (shortening of the overall length of the optical system) and suppresses the occurrence of field curvature accompanying zooming from the wide angle edge to the telephoto edge, thereby enabling high optical performance to be maintained over the entire zoom range.

Below the lower limit of conditional expression (1), the contribution of the second lens group to zooming becomes too large, whereby field curvature that occurs accompanying zooming becomes large, making correction thereof difficult. Meanwhile, above the upper limit of conditional expression (1), the contribution of the second lens group to zooming becomes too small, whereby the distance that the second lens group is moved during zooming increases, making shortening of the overall length of the optical system difficult.

An even more desirable effect can be expected by satisfying conditional expression (1) to be within the following range.

4.0≦|β2T/β2W|≦10.9 (1a)

Satisfying the range prescribed by conditional expression (1a) enables a zoom lens having an even smaller size and high optical performance to be realized.

Satisfying conditional expression (1a) to be within the following range enables a zoom lens having yet a smaller size and high optical performance to be realized.

5.0≦|β2T/β2W|≦9.8 (1b)

In the zoom lens according to the present invention, the first lens group is moved along the optical axis to perform zooming; the second lens group and the lens groups thereafter are moved along the optical axis to correct image plane variation that accompanies zooming; and the first lens group may be moved along the optical axis, toward the object side, to perform focusing from a focused state at infinity to a focused state at the minimum object distance.

The function of zooming is primarily given to the first lens group and the correction of image plane variation that accompanies zooming is assigned to the second lens group and the lens groups thereafter, thereby enabling image plane variation to be corrected efficiently. The first lens group is further assigned focusing, whereby image plane variation that accompanies focusing can be suppressed and optical performance can be favorably maintained.

The zoom lens according to the present invention preferably satisfies the following conditional expression, where β2W is magnification of the second lens group at the wide angle edge.

−0.5≦β2W≦−0.1 (2)

Conditional expression (2) prescribes magnification of the second lens group at the wide angle edge. Satisfying conditional expression (2) suppresses comatic aberration and field curvature occurring at the second lens group at the wide angle edge and enables a zoom lens having a small size and high optical performance to be realized.

Below the lower limit of conditional expression (2), the refractive power of the second lens group becomes too weak, whereby the overall length of the optical system increases, making reductions in the size of the optical system difficult. Meanwhile, above the upper limit of conditional expression (2), the refractive power of the second lens group becomes too strong, whereby correction of the comatic aberration and field curvature occurring at the wide angle edge becomes difficult.

An even more desirable effect can be expected by satisfying conditional expression (2) to be within the following range.

−0.45≦β2W≦−0.15 (2a)

Satisfying the range prescribed by conditional expression (2a) enables a zoom lens having an even smaller size and high optical performance to be realized.

Satisfying conditional expression (2a) to be within the following range enables a zoom lens having yet a smaller size and high optical performance to be realized.

−0.3≦β2W≦−0.2 (2b)

The zoom lens according to the present invention preferably satisfies the following conditional expression, where β2T is magnification of the second lens group at the telephoto edge.

−4.50≦β2T≦−1.45 (3)

Conditional expression (3) prescribes magnification of the second lens group at the telephoto edge. Satisfying conditional expression (3) suppresses comatic aberration and field curvature occurring at the second lens group at the telephoto edge and enables a zoom lens having a small size and high optical performance to be realized.

Below the lower limit of conditional expression (3), the refractive power of the second lens group becomes too weak, whereby the overall length of the optical system increases, making reductions in the size of the optical system difficult. Meanwhile, above the upper limit of conditional expression (3), the refractive power of the second lens group becomes too strong, whereby correction of the comatic aberration and field curvature occurring at the telephoto edge becomes difficult.

An even more desirable effect can be expected by satisfying conditional expression (3) to be within the following range.

−4.0≦β2T≦−2.0 (3a)

Satisfying the range prescribed by conditional expression (3a) enables a zoom lens having an even smaller size and high optical performance to be realized.

Satisfying conditional expression (3a) to be within the following range enables a zoom lens having yet a smaller size and high optical performance to be realized.

−3.5≦β2T≦−2.5 (3b)

The zoom lens according to the present invention preferably satisfies the following conditional expression, where βLT is magnification of the lens group disposed farthest on the image side, at the telephoto edge.

0.3≦βLT≦1.0 (4)

Conditional expression (4) prescribes magnification of the lens group disposed farthest on the image side, at the telephoto edge. Satisfying conditional expression (4) suppresses spherical aberration and field curvature occurring at the lens group disposed farthest on the image side, at the telephoto edge, thereby enabling a zoom lens having a small size and high optical performance to be realized.

Below the lower limit of conditional expression (4), the refractive power of the lens group disposed farthest on the image side becomes too strong, whereby correction of spherical aberration and field curvature occurring at the telephoto edge becomes difficult. Meanwhile, above the upper limit of conditional expression (4), the refractive power of the lens group disposed farthest on the image side becomes too weak, whereby the overall length of the optical system increases, making reductions in the size of the optical system difficult.

An even more desirable effect can be expected by satisfying conditional expression (4) to be within the following range.

0.4≦βLT≦0.9 (4a)

Satisfying the range prescribed by conditional expression (4a) enables a zoom lens having an even smaller size and high optical performance to be realized.

Satisfying conditional expression (4a) to be within the following range enables a zoom lens having yet a smaller size and high optical performance to be realized.

0.5≦βLT≦0.8 (4b)

To achieve an object, the zoom lens of the present invention further has the following configuration.

In other words, in the zoom lens according to the present invention, in the second lens group, an aperture stop prescribing a given aperture is disposed and when zooming from the wide angle edge to the telephoto edge is performed, the aperture stop moves together with the second lens group, from the image side toward the object side.

When a bright optical system is to be realized, although the diameter of the aperture stop has to be increased, increasing the diameter affects the outer diameter of the optical system, making reduction of the diameter of the optical system difficult. In the zoom lens according to the present invention, as described above, a positive lens is disposed farthest on the object side of the second lens group, whereby incident light rays are converged by the positive lens, facilitating reductions in the diameters of the second lens group and lens groups thereafter. Thus, in the zoom lens according to the present invention, disposal of the aperture stop in the second lens group enables a bright optical system to be realized without increasing the outer diameter of the optical system.

Further, if the aperture stop is fixed, the aperture stop becomes an impediment during zooming and the distance that the lens groups move is limited. As a result, high zoom ratios become difficult to achieve and aberration correction becomes difficult. If a zoom lens having a fixed aperture stop, high zoom ratio, and favorable optical performance is to be realized, a problem arises in that movement areas of the lens groups have to have some margin, which invites increases in the size of the optical system (increased overall length of the optical system). Thus, in the zoom lens according to the present invention, the aperture stop is disposed in the second lens group and by moving the aperture stop together with the second lens group during zooming, the lens groups can move a sufficient distance even in a limited area, thereby enabling a reduction in size, a high zoom ratio, and improved optical performance.

The zoom lens according to the present invention preferably satisfies the following conditional expression, where f1 is the focal length of the first lens group and f2 is the focal length of the second lens group.

0.35≦f1|/f2≦0.85 (5)

Conditional expression (5) prescribes a ratio of the focal length of the first lens group and the focal length of the second lens group. Satisfying conditional expression (5) enables spherical aberration and field curvature occurring at the first lens group to be corrected properly by the second lens group, whereby high optical performance can be obtained.

Below the lower limit of conditional expression (5), the refractive power of the first lens group becomes too strong, whereby field curvature occurring at the first lens group becomes too great and cannot be corrected at the second lens group. Meanwhile, above the upper limit of conditional expression (5), the refractive power of the second lens group becomes too strong, whereby spherical aberration occurring at the first lens group is over-corrected, making high optical performance difficult to obtain.

An even more desirable effect can be expected by satisfying conditional expression (5) to be within the following range.

0.4≦|f1|/f2≦0.7 (5a)

Satisfying the range prescribed by conditional expression (5a) enables a zoom lens having higher optical performance to be realized.

Satisfying conditional expression (5a) to be within the following range enables a zoom lens having even higher optical performance to be realized.

0.5≦|f1|/f≦20.7 (5b)

The zoom lens according to the present invention preferably satisfies the following conditional expression, where f2 is the focal length of the second lens group and f3 is the focal length of the third lens group.

0.2≦|f2/f3|≦1.0 (6)

Conditional expression (6) prescribes a ratio of the focal length of the second lens group and the focal length of the third lens group. Satisfying conditional expression (6) enables comatic aberration and field curvature occurring at the second lens group to be properly corrected at the third lens group, whereby high optical performance can be obtained.

Below the lower limit of conditional expression (6), the refractive power of the third lens group becomes too strong, whereby field curvature cannot be corrected properly. Meanwhile, above the upper limit of conditional expression (6), the refractive power of the second lens group becomes too strong, whereby the occurrence of comatic aberration becomes conspicuous, making correction thereof by the third lens group difficult.

An even more desirable effect can be expected by satisfying conditional expression (6) to be within the following range.

0.3≦|f2/f3|≦0.9 (6a)

Satisfying the range prescribed by conditional expression (6a) enables a zoom lens having even higher optical performance to be realized.

Satisfying conditional expression (6a) to be within the following range enables a zoom lens having yet higher optical performance to be realized.

0.4≦|f2/f3|≦0.8 (6b)

To achieve an object, the following conditions are set.

In the zoom lens according to the present invention, the first lens group is preferably configured to include at least one positive lens and one negative lens. Further, the following conditional expressions are preferably satisfied, where υd1p is the Abbe number for d-line of the positive lens included in the first lens group and υd1n is the Abbe number for d-line of the negative lens included in the first lens group.

υd1p≦41.0 (7)

υd1n≧50.0 (8)

Conditional expression (7) prescribes an Abbe number for d-line of the positive lens included in the first lens group and represents a condition for favorably correcting chromatic difference of magnification occurring at the negative lens included in the first lens group. Conditional expression (8) prescribes an Abbe number for d-line of the negative lens included in the first lens group and represents a condition for reducing chromatic difference of magnification occurring at the first lens group and for simultaneously correcting spherical aberration and field curvature favorably.

Satisfying conditional expressions (7) and (8) enables favorable correction of chromatic difference of magnification occurring at the negative lens included in the first lens group and favorable correction of spherical aberration and field curvature, whereby high optical performance can be obtained. In particular, aberration occurring with respect to light from the visible light region to the near infrared region can be favorably corrected.

Above the upper limit of conditional expression (7), longitudinal chromatic aberration and chromatic difference of aberration occurring at the first lens group with respect to light from visible light region to near infrared region increases, whereby optical performance drops significantly.

An even more desirable effect can be expected by satisfying conditional expression (7) to be within the following limit.

υd1p≦33.5 (7a)

Satisfying the limit prescribed by conditional expression (7a) enables a zoom lens having even higher optical performance to be realized.

Satisfying conditional expression (7a) to be within the following limit enables a zoom lens having yet higher optical performance to be realized.

υd1p≦26.0 (7b)

Below the lower limit of conditional expression (8), longitudinal chromatic aberration occurring at the first lens group with respect to light from the visible light region to the near infrared region increases, whereby optical performance drops significantly.

An even more desirable effect can be expected by satisfying conditional expression (8) to be within the following limit.

υd1n≧55.0 (8a)

Satisfying the limit prescribed by conditional expression (8a) enables a zoom lens having even higher optical performance to be realized.

Satisfying conditional expression (8a) to be within the following limit enables a zoom lens having yet higher optical performance to be realized.

υd1n60.0 (8b)

The zoom lens according to the present invention preferably satisfies the following conditional expression, where υd2pa is an average value of the Abbe number for d-line of the positive lenses included in the second lens group.

υd2pa≧68.0 (9)

Conditional expression (9) prescribes an average value of the Abbe number for d-line of the positive lenses in the second lens group and represents a condition for favorably correcting chromatic difference of magnification occurring at the second lens group with respect to light from the visible light region to the near infrared region.

Below the lower limit of conditional expression (9), the correction of chromatic difference of magnification occurring at the second lens group with respect to light from the visible light region to the near infrared region becomes difficult, whereby optical performance drops significantly.

An even more desirable effect can be expected by satisfying conditional expression (9) to be within the following limit.

υd2pa≧72.0 (9a)

Satisfying the limit prescribed by conditional expression (9a) enables a zoom lens having even higher optical performance to be realized.

Satisfying conditional expression (9a) to be within the following limit enables a zoom lens having yet higher optical performance to be realized.

υd2pa≧76.0 (9b)

In the zoom lens according to the present invention, the first lens group may be configured to include sequentially from the object side, a negative lens, a negative lens, and a positive lens successively disposed. With such a configuration, aberration occurring consequent to the negative refractive power can be dispersed by disposing the two negative lenses, enabling the occurrence of spherical aberration and field curvature to be reduced. Further, spherical aberration and field curvature occurring consequent to the two negative lenses can be corrected by the positive lens disposed on the image side of the negative lenses. As a result, spherical aberration and field curvature occurring at the first lens group can be effectively corrected.

In the zoom lens according to the present invention, the third lens group may be configured to include sequentially from the object side, a negative lens and a positive lens successively disposed. With such a configuration, field curvature and comatic aberration occurring at the first and second lens groups can be corrected at the third lens group. More specifically, field curvature occurring at the first and second lens groups can be corrected by the negative lens of the third lens group. Further, comatic aberration occurring at the first and second lens groups can be corrected by the positive lens of the third lens group.

In the zoom lens according to the present invention, since field curvature occurring at the first and second lens groups is corrected at the third lens group, the negative lens farthest on the object side of the third lens group preferably has a concave surface on the object side of the lens. The following condition expression is preferably satisfied, where R31 is the radius of curvature of the surface on the object side of the negative lens disposed farthest on the object side of the third lens group and R32 is the radius of curvature of the surface on the image side of the negative lens disposed farthest on the object side of the third lens group.

−1.5≦(R31+R32)/(R31−R32)≦0.3 (10)

Conditional expression (10) prescribes a radius of curvature of the surface on the object side and a radius of curvature of the surface on the image side of the concave lens disposed farthest on the object side of the third lens group. Satisfying conditional expression (10) enables field curvature occurring at the first and second lens groups to be favorably corrected at the third lens group.

Below the lower limit of conditional expression (10), the correction of field curvature by the concave lens becomes excessive, whereby favorable optical performance cannot be obtained. Meanwhile, above the upper limit of conditional expression (10), the correction of field curvature by the concave lens becomes insufficient, whereby favorable optical performance cannot be obtained.

An even more desirable effect can be expected by satisfying conditional expression (10) to be within the following range.

−1.2≦(R31+R32)/(R31−R32)≦0.2 (10a)

Satisfying the range prescribed by conditional expression (10a) enables a zoom lens having even higher optical performance to be realized.

Satisfying conditional expression (10a) to be within the following range enables a zoom lens having yet higher optical performance to be realized.

−0.8≦(R31+R32)/(R31−R32)≦0.1 (10b)

The zoom lens according to the present invention preferably satisfies the following conditional expression, where X2 is the distance that the second lens group is moved during zooming from the wide angle edge to the telephoto edge, f1 is the focal length of the first lens group, and f2 is the focal length of the second lens group.

4.5≦|X2|²/(|f1|×f2)≦16.5 (11)

The distance X2 that the second lens group is moved is the distance that the second lens group moves on the optical axis with respect to a fixed point within a finite distance on the optical axis, when the second group moves from the wide angle edge toward the telephoto edge.

Conditional expression (11) prescribes a relation of the distance that the second lens group moves during zooming from the wide angle edge to the telephoto edge and, the focal length of the first lens group and the focal length of the second lens group. Satisfying conditional expression (11) enables the distance that the second lens group moves during zooming from the wide angle edge to the telephoto edge to be properly set while maintaining optical performance and facilitating shortening of the overall length of the optical system.

Below the lower limit of conditional expression (11), the distance that the second lens group moves during zooming can be decreased, however, aberration accompanying zooming becomes difficult to suppress. Meanwhile, above the upper limit of conditional expression (11), the distance that the second lens group moves during zooming increases, whereby the overall length of the optical system increases.

An even more desirable effect can be expected by satisfying conditional expression (11) to be within the following range.

6.8≦|X2|²/(|f1|×f2)≦15.2 (11a)

Satisfying the range prescribed by conditional expression (11a) enables a zoom lens having an even smaller size and high optical performance to be realized.

Satisfying conditional expression (11a) to be within the following range enables a zoom lens having yet a smaller size and high optical performance can be realized.

7.5≦|X2|²/(|f1|×f2)≦14.5 (11b)

The zoom lens according to the present invention preferably satisfies the following conditional expression, where f2 is the focal length of the second lens group and fLw is the composite focal length of all lens groups from the third lens group and thereafter, at the wide angle edge.

0.3≦f2/fLw≦1.1 (12)

Conditional expression (12) prescribes a ratio of the focal length of the second lens group and the composite focal length of all lens groups from the third lens group and thereafter, at the wide angle edge. Satisfying conditional expression (12) enables comatic aberration occurring at the second lens group, at the wide angle edge to be favorably corrected at the third lens group and the lens groups thereafter.

Below the lower limit of conditional expression (12), the refractive power of the third lens group and the lens groups thereafter becomes weak, whereby comatic aberration occurring at the second lens group becomes difficult to correct favorably. Meanwhile, above the upper limit of conditional expression (12), the refractive power of the second lens group becomes too weak, whereby shortening of the overall length of the optical system becomes difficult.

An even more desirable effect can be expected by satisfying conditional expression (12) to be within the following range.

0.48≦f2/fLw≦0.92 (12a)

Satisfying the range prescribed by conditional expression (12a) enables a zoom lens having an even smaller size and high optical performance to be realized.

Satisfying conditional expression (12a) to be within the following range enables a zoom lens having yet a smaller size and high optical performance to be realized.

0.55≦f2/fLw≦0.85 (12b)

As described, according to the present invention, by providing the configuration described above, a zoom lens can be realized that is compact and has high optical performance enabling favorable correction of various types of aberration over the entire zoom range. Further, an effect is achieved in that a compact, large diameter zoom lens with a high zoom ratio can be realized. In addition, a zoom lens can be realized that can favorably correct various types of aberration occurring with respect to light from the visible light region to the near infrared region.

Embodiments of the zoom lens according to the present invention will be described in detail with reference to the accompanying drawings. The present invention is not limited by the embodiments hereinafter.

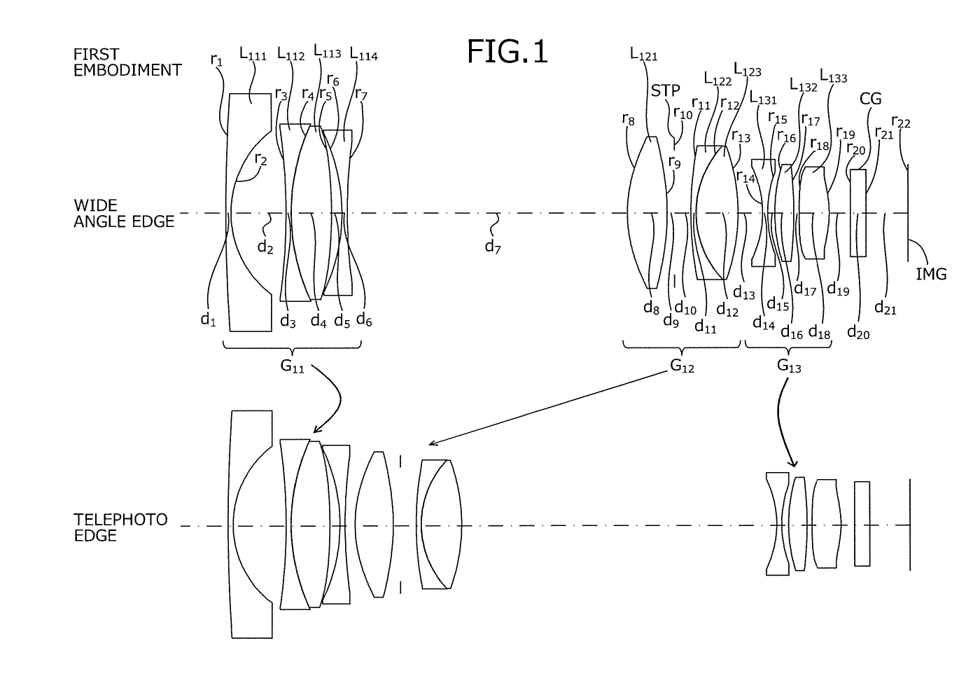

FIG. 1 is a diagram depicting, along the optical axis, a configuration of the zoom lens according to a first embodiment. The zoom lens is configured to include sequentially from the object side nearest a non-depicted object, a first lens group G₁₁ having a negative refractive power, a second lens group G₁₂ having a positive refractive power, and a third lens group G₁₃ having a positive refractive power. A cover glass CG is disposed between the third lens group G₁₃ and the image plane IMG.

The first lens group G₁₁ is configured to include sequentially from the object side, a negative lens L₁₁₁, a negative lens L₁₁₂, a positive lens L₁₁₃, and a negative lens L₁₁₄. The negative lens L₁₁₂ and the positive lens L₁₁₃ are cemented. The positive lens L₁₁₃ has an aspheric surface on the image plane IMG side.

The second lens group G₁₂ is configured to include sequentially from the object side, a positive lens L₁₂₁, an aperture stop STP prescribing a given aperture, a negative lens L₁₂₂, and a positive lens L₁₂₃. Both surfaces of the positive lens L₁₂₁ are aspheric. The negative lens L₁₂₂ and the positive lens L₁₂₃ are cemented.

The third lens group G₁₃ is configured to include sequentially from the object side, a negative lens L₁₃₁, a positive lens L₁₃₂, and a positive lens L₁₃₃. The negative lens L₁₃₁ has a concave surface on the object side. Both surfaces of the positive lens L₁₃₃ are aspheric.

The zoom lens moves the first lens group G₁₁ along the optical axis, to form on the image plane IMG side, a convex locus and thereby, performs zooming from the wide angle edge to the telephoto edge. Further, the zoom lens moves the second lens group G₁₂ along the optical axis, from the image plane IMG side toward the object side and moves the third lens group G₁₃ along the optical axis, to form on the object side, a gradual convex locus and thereby, corrects the position of the image plane IMG accompanying zooming. During correction, the aperture stop STP moves together with the second lens group G₁₂. The zoom lens further moves the first lens group G₁₁ along the optical axis, toward the object side to perform focusing from a focused state at infinity to a focused state at the minimum object distance.

Here, values of various types of data related to the zoom lens according to the first embodiment are given.

Focal length of entire zoom lens=3.19 (wide angle edge) to 19.44 (telephoto edge)
F number (FNO)=1.23 (wide angle edge) to 3.44 (telephoto edge)
Half angle of view (ω)=58.37 (wide angle edge) to 8.53 (telephoto edge)
Focal length of first lens group G₁₁ (f1)=−8.91
Focal length of second lens group G₁₂ (f2)=13.42
Focal length of third lens group G₁₃ (f3)=20.43
Zoom ratio=6.10
(Lens data)
r₁=157.592

d₁=0.50 nd₁=1.83 υd₁=42.72

r₂=9.500

d₂=5.28

r₃=−56.402

d₃=0.50 nd₂=1.49 υd₂=70.44

r₄=19.091

d₄=3.86 nd₃=1.82 υd₃=24.06

r₅=−48.424 (aspheric)

d₅=1.02

r₆=−16.500

d₆=0.50 nd₄=1.52 υd₄=64.20

r₇=47.208

d₇=D(7) (variable)

r₈=12.507 (aspheric)

d₈=3.83 nd₅=1.55 υd₅=71.68

r₉=−21.857 (aspheric)

d₉=0.71

r₁₀=∞ (aperture stop)

d₁₀=1.57

r₁₁=31.697

d₁₁=0.50 nd₆=1.72 υd₆=29.50

r₁₂=9.003

d₁₂=4.03 nd₇=1.44 υd₇=95.10

r₁₃=−17.916

d₁₃=D(13) (variable)

r₁₄=−9.959

d₁₄=0.50 nd₈=1.58 υd₈=40.89

r₁₅=11.066

d₁₅=0.68

r₁₆=15.141

d₁₆=1.83 nd₉=1.88 υd₉=40.81

r₁₇=−39.802

d₁₇=0.50

r₁₈=49.128 (aspheric)

d₁₈=2.92 nd₁₀=1.50 υd₁₀=81.56

r₁₉=−9.723 (aspheric)

d₁₉=D (19) (variable)

r₂₀=∞

d₂₀=1.50 nd₁₁=1.52 υd₁₁=64.20

r₂₁=∞

d₂₁=4.00

r₂₂=∞ (image plane)
Constant of the cone (k) and aspheric coefficients (A, B, C, D, E)
(Fifth order)
k=0,

### A=0,

B=−6.72458×10⁻⁵, C=−2.40695×10⁻⁷,
D=2.61052×10⁻⁹, E=−3.95672×10⁻¹¹
(Eighth order)
k=0,

### A=0,

B=−9.69395×10⁻⁵, C=−9.51005×10⁻⁷,
D=4.02158×10⁻⁸, E=−6.43542×10⁻¹⁰
(Ninth order)
k=0,

### A=0,

B=1.00663×10⁻⁴, C=−1.18082×10⁻⁶,
D=4.06019×10⁻⁸, E=−6.35633×10⁻¹⁰
(Eighteenth order)
k=0,

### A=0,

B=5.35557×10⁻⁴, C=2.45046×10⁻⁵,
D=−1.67573×10⁻⁷, E=2.92909×10⁻⁸
(Nineteenth order)
k=0,

### A=0,

B=8.27909×10⁻⁴, C=5.14824×10⁻⁵,
D=−2.72286×10⁶, E=1.39662×10⁻⁷
(Zoom data)

| | Wide angle edge | Telephoto edge |
|---|---|---|
| D(7) | 26.85 | 1.00 |
| D(13) | 2.35 | 31.40 |
| D(19) | 2.03 | 1.35 |

(Values related to conditional expression (1))

|β2T/β2W|=5.87

β2T: Magnification of second lens group G₁₂ at telephoto edge
β2W: Magnification of second lens group G₁₂ at wide angle edge
(Values related to conditional expression (2))

β2W=−0.43

(Values related to conditional expression (3))

β2T=−2.53

(Values related to conditional expression (4))

βLT=0.86

βLT: Magnification of lens group (third lens group G₁₃) disposed farthest on image side, at telephoto edge
(Values related to conditional expression (5))

|f1|/f2=0.66

(Values related to conditional expression (6))

|f2/f3|=0.66

(Values related to conditional expression (7))

υd1p=24.06

υd1p: Abbe number for d-line of positive lens (positive lens L₁₁₃) included in first lens group G₁₁
(Values related to conditional expression (8))

υd1n=70.44

υd1n: Abbe number for d-line of negative lens (negative lens L₁₁₂) included in first lens group G₁₁
(Values related to conditional expression (9))

υd2pa=83.39

υd2pa: Average value of Abbe number for d-line of positive lenses included in second lens group G₁₂
(Values related to conditional expression (10))

(R31+R32)/(R31−R32)=−0.05

R31: Radius of curvature of surface on object side of negative lens L₁₃₁ disposed farthest on object side of third lens group G₁₃
R32: Radius of curvature of surface on image side of negative lens L₁₃₁ disposed farthest on object side of third lens group G₁₃
(Values related to conditional expression (11))

|X2|²/(|f1|×f2)=6.73

X2: Distance that second lens group G₁₂ is moved during zooming from wide angle edge to telephoto edge (=28.38)
(Values related to conditional expression (12))

f2/fLw=0.66

fLw: Composite focal length of third lens group G₁₃ and all lens groups disposed thereafter, at wide angle edge

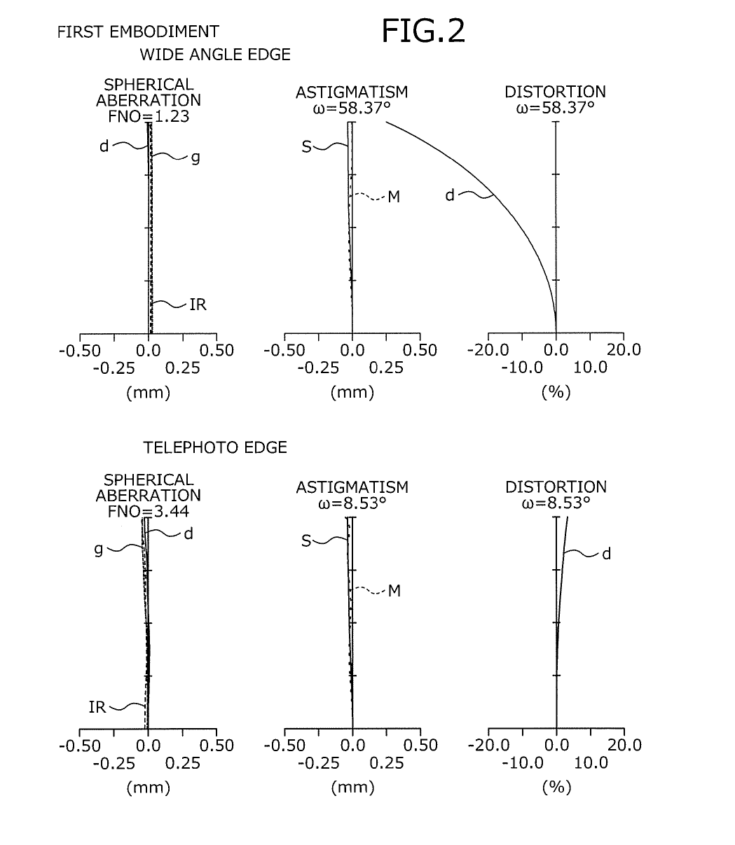

FIG. 2 is a diagram of various types of aberration occurring in the zoom lens according to the first embodiment. In the diagram, for curves depicting spherical aberration, the vertical axis represents the F number (FNO), solid lines depict wavelength characteristics corresponding to the d-line (λ=587.56 nm), dotted lines depict wavelength characteristics corresponding to the g-line (λ=435.84 nm), and dashed lines depict wavelength characteristics corresponding to IR rays (λ=850.00 nm). For curves depicting astigmatism, the vertical axis represents the half angle of view (ω) and wavelength characteristics corresponding to d-line are depicted, where solid lines depict characteristics of the sagittal plane (S), and dashed lines depict characteristics of the meridonal plane (M). For curves depicting distortion, the vertical axis represents the half angle of view (ω), and wavelength characteristics corresponding to d-line are depicted.

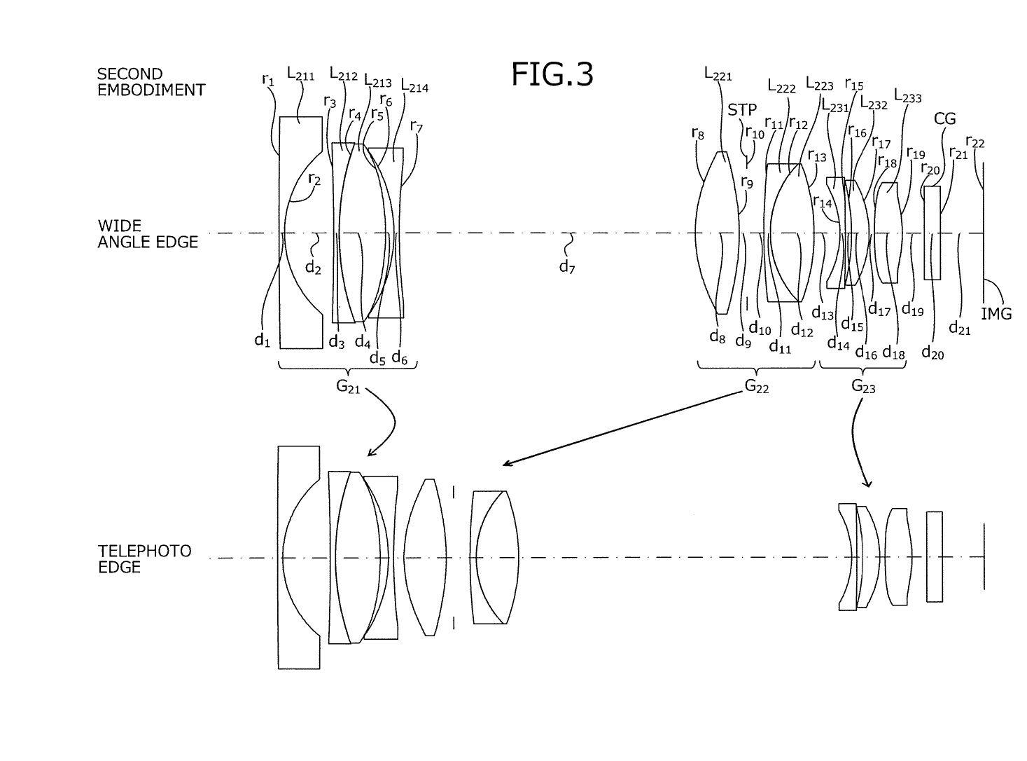

FIG. 3 is a diagram depicting, along the optical axis, a configuration of the zoom lens according to a second embodiment. The zoom lens is configured to include sequentially from the object side nearest a non-depicted object, a first lens group G₂₁ having a negative refractive power, a second lens group G₂₂ having a positive refractive power, and a third lens group G₂₃ having a positive refractive power. The cover glass CG is disposed between the third lens group G₂₃ and the image plane IMG.

The first lens group G₂₁ is configured to include sequentially from the object side, a negative lens L₂₁₁, a negative lens L₂₁₂, a positive lens L₂₁₃, and a negative lens L₂₁₄. The negative lens L₂₁₂ and the positive lens L₂₁₃ are cemented. The positive lens L₂₁₃ has an aspheric surface on the image plane IMG side.

The second lens group G₂₂ is configured to include sequentially from the object side, a positive lens L₂₂₁, the aperture stop STP prescribing a given aperture, a negative lens L₂₂₂, and a positive lens L₂₂₃. Both surfaces of the positive lens L₂₂₁ are aspheric. The negative lens L₂₂₂ and the positive lens L₂₂₃ are cemented.

The third lens group G₂₃ is configured to include sequentially from the object side, a negative lens L₂₃₁, a positive lens L₂₃₂, and a positive lens L₂₃₃. The negative lens L₂₃₁ has a concave surface on the object side. Both surfaces of the positive lens L₂₃₃ are aspheric.

The zoom lens moves the first lens group G₂₁ along the optical axis, to form on the image plane IMG side, a convex locus and thereby, performs zooming from the wide angle edge to the telephoto edge. Further, the zoom lens moves the second lens group G₂₂ along the optical axis, from the image plane IMG side toward the object side and moves the third lens group G₂₃ along the optical axis to form on the object side, a gradual convex locus and thereby, corrects the position of the image plane IMG accompanying zooming. During correction, the aperture stop STP moves together with the second lens group G₂₂. The zoom lens further moves the first lens group G₂₁ along the optical axis, toward the object side to perform focusing from a focused state at infinity to a focused state at the minimum object distance.

Here, values of various types of data related to the zoom lens according to the second embodiment are given.

Focal length of entire zoom lens=3.19 (wide angle edge) to 19.44 (telephoto edge)
F number (FNO)=1.23 (wide angle edge) to 3.47 (telephoto edge)
Half angle of view (ω)=63.46 (wide angle edge) to 9.03 (telephoto edge)
Focal length of first lens group G₂₁ (f1)=−9.02
Focal length of second lens group G₂₂ (f2)=13.71
Focal length of third lens group G₂₃ (f3)=20.36
Zoom ratio=6.10
(Lens data)
r₁=579.202

d₁=0.50 nd₁=1.90 υd₁=37.37

r₂=9.500

d₂=4.56

r₃=−218.921

d₃=0.50 nd₂=1.64 υd₂=55.45

r₄=23.130

d₄=4.30 nd₃=1.82 υd₃=24.06

r₅=−22.947 (aspheric)

d₅=0.79

r₆=−12.801

d₆=0.50 nd₄=1.52 υd₄=52.15

r₇=53.596

d₇=D(7) (variable)

r₈=12.385 (aspheric)

d₈=4.09 nd₅=1.55 υd₅=71.68

r₉=−20.051 (aspheric)

d₉=0.71

r₁₀=∞ (aperture stop)

d₁₀=1.57

r₁₁=53.272

d₁₁=0.60 nd₆=1.67 υd₆=32.17

r₁₂=8.806

d₁₂=4.08 nd₇=1.44 υd₇=95.10

r₁₃=−17.193

d₁₃=D(13) (variable)

r₁₄=−8.512

d₁₄=0.50 nd₈=1.52 υd₈=52.15

r₁₅=−211.125

d₁₅=0.57

r₁₆=−19.080

d₁₆=1.67 nd₉=1.50 υd₉=81.61

r₁₇=−9.123

d₁₇=0.50

r₁₈=30.680 (aspheric)

d₁₈=2.59 nd₁₀=1.50 υd₁₀=81.56

r₁₉=−10.864 (aspheric)

d₁₉=D(19) (variable)

r₂₀=∞

d₂₀=1.50 nd₁₁=1.52 υd₁₁=64.20

r₂₁=∞

d₂₁=4.00

r₂₂=∞ (image plane)
Constant of the cone (k) and aspheric coefficients (A, B, C, D, E)
(Fifth order)
k=0,

### A=0,

B=−9.10507×10⁻⁵, C=−5.33991×10⁻⁷,
D=2.86663×10⁻⁹, E=−7.37298×10⁻¹¹
(Eighth order)
k=0,

### A=0,

B=−9.81882×10⁻⁵, C=−6.15235×10⁻⁷,
D=2.80365×10⁻⁸, E=−4.53885×10⁻¹⁰
(Ninth order)
k=0,

### A=0,

B=1.12174×10⁻¹, C=−8.11729×10⁻⁷,

### D=2.63785×10⁻⁸, E=−4.19895×10

(Eighteenth order)
k=0,

### A=0,

B=2.38585×10⁻⁴, C=2.31778×10⁻⁵,
D=−3.13210×10⁻⁷, E=3.70085×10⁻⁸
(Nineteenth order)
k=0,

### A=0,

B=5.36748×10⁻⁴, C=4.77277×10⁻⁵,
D=−2.53469×10⁻⁶, E=1.21543×10⁻⁷
(Zoom data)

| | Wide angle edge | Telephoto edge |
|---|---|---|
| D(7) | 27.49 | 1.00 |
| D(13) | 2.40 | 32.02 |
| D(19) | 2.03 | 1.43 |

(Values related to conditional expression (1))

|β2T/β2W|=5.88

β2T: Magnification of second lens group G₂₂ at telephoto edge
β2W: Magnification of second lens group G₂₂ at wide angle edge
(Values related to conditional expression (2))

β2W=−0.43

(Values related to conditional expression (3))

β2T=−2.53

(Values related to conditional expression (4))

βLT=0.85

βLT: Magnification of lens group (third lens group G₂₃) disposed farthest on image side, at telephoto edge
(Values related to conditional expression (5))

|f1|/f2=0.66

(Values related to conditional expression (6))

|f2/f3|=0.67

(Values related to conditional expression (7))

υd1p=24.06

υd1p: Abbe number for d-line of positive lens (positive lens L₂₁₃) included in first lens group G₂₁
(Values related to conditional expression (8))

υd1n=52.15

υd1n: Abbe number for d-line of negative lens (negative lens L₂₁₄) included in first lens group G₂₁
(Values related to conditional expression (9))

υd2pa=83.39

υd2pa: Average value of Abbe number for d-line of positive lenses included in second lens group G₂₂
(Values related to conditional expression (10))

(R31+R32)/(R31−R32)=−1.08

R31: Radius of curvature of surface on object side of negative lens L₂₃₁ disposed farthest on object side of third lens group G₂₃
R32: Radius of curvature of surface on image side of negative lens L₂₃₁ disposed farthest on object side of third lens group G₂₃
(Values related to conditional expression (11))

|X2|²/(|f1|×f2)=6.82

X2: Distance that second lens group G₂₂ is moved during zooming from wide angle edge to telephoto edge (=29.03)
(Values related to conditional expression (12))

f2/fLw=0.67

fLw: Composite focal length of third lens group G₂₃ and all lens groups disposed thereafter, at wide angle edge

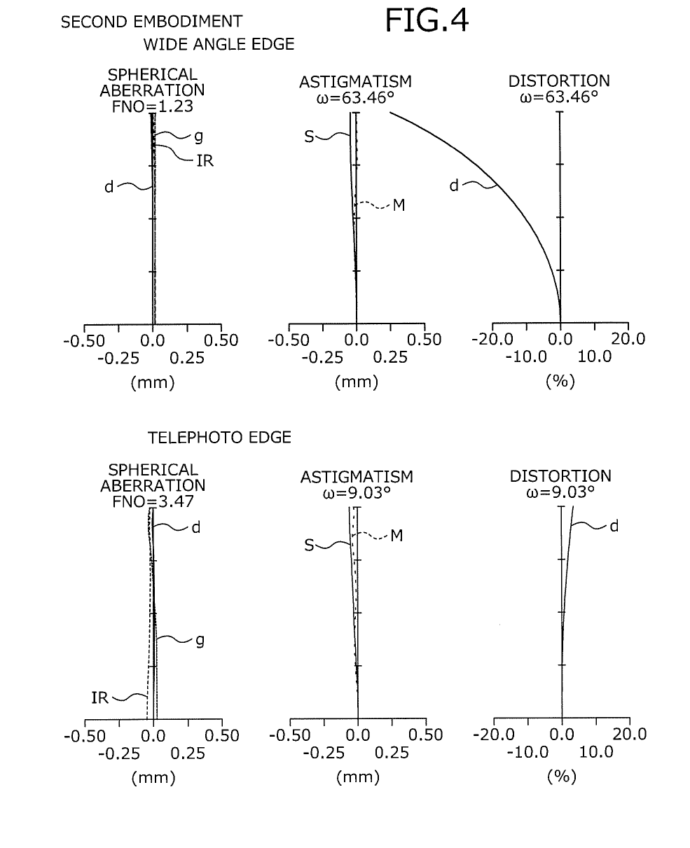

FIG. 4 is a diagram of various types of aberration occurring in the zoom lens according to the second embodiment. In the diagram, for curves depicting spherical aberration, the vertical axis represents the F number (FNO), solid lines depict wavelength characteristics corresponding to the d-line (λ=587.56 nm), dotted lines depict wavelength characteristics corresponding to the g-line (λ=435.84 nm), and dashed lines depict wavelength characteristics corresponding to IR rays (λ=850.00 nm). For curves depicting astigmatism, the vertical axis represents the half angle of view (ω) and wavelength characteristics corresponding to d-line are depicted, where solid lines depict characteristics of the sagittal plane (S), and dashed lines depict characteristics of the meridonal plane (M). For curves depicting distortion, the vertical axis represents the half angle of view (ω), and wavelength characteristics corresponding to d-line are depicted.

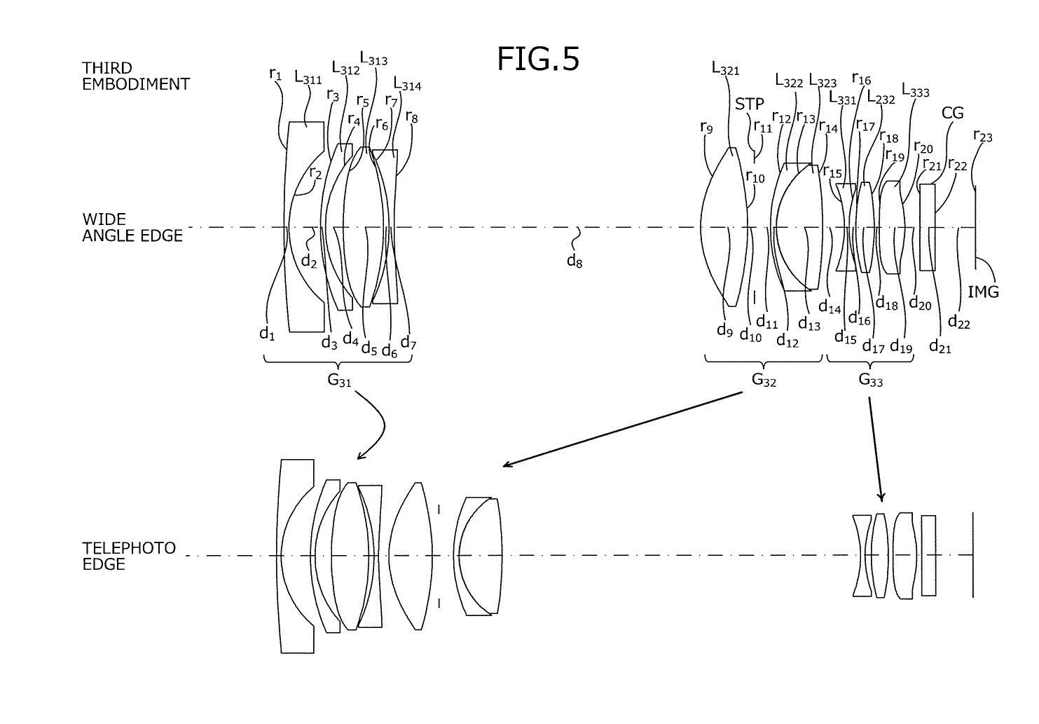

FIG. 5 is a diagram depicting, along the optical axis, a configuration of the zoom lens according to a third embodiment. The zoom lens is configured to include sequentially from the object side nearest a non-depicted object, a first lens group G₃₁ having a negative refractive power, a second lens group G₃₂ having a positive refractive power, and a third lens group G₃₃ having a positive refractive power. The cover glass CG is disposed between the third lens group G₃₃ and the image plane IMG.

The first lens group G₃₁ is configured to include sequentially from the object side, a negative lens L₃₁₁, a negative lens L₃₁₂, a positive lens L₃₁₃, and a negative lens L₃₁₄. The positive lens L₃₁₃ has an aspheric surface on the object side. The negative lens L₃₁₄ has an aspheric surface on the image plane IMG side.

The second lens group G₃₂ is configured to include sequentially from the object side, a positive lens L₃₂₁, the aperture stop STP prescribing a given aperture, a negative lens L₃₂₂, and a positive lens L₃₂₃. Both surfaces of the positive lens L₃₂₁ are aspheric. The negative lens L₃₂₂ and the positive lens L₃₂₃ are cemented.

The third lens group G₃₃ is configured to include sequentially from the object side, a negative lens L₃₃₁, a positive lens L₃₃₂, and a positive lens L₃₃₃. The negative lens L₃₃₁ has a concave surface on the object side. Both surfaces of the positive lens L₃₃₃ are aspheric.

The zoom lens moves the first lens group G₃₁ along the optical axis, to form on the image plane IMG side, a convex locus and thereby, performs zooming from the wide angle edge to the telephoto edge. Further, the zoom lens moves the second lens group G₃₂ along the optical axis, from the image plane IMG side toward the object side and moves the third lens group G₃₃ along the optical axis, from the object side toward the image plane IMG side and thereby, corrects the position of the image plane IMG accompanying zooming. During correction, the aperture stop STP moves together with the second lens group G₃₂. The zoom lens further moves the first lens group G₃₁ along the optical axis, toward the object side to perform focusing from a focused state at infinity to a focused state at the minimum object distance.

Here, values of various types of data related to the zoom lens according to the third embodiment are given.

Focal length of entire zoom lens=3.09 (wide angle edge) to 24.31 (telephoto edge)
F number (FNO)=1.23 (wide angle edge) to 5.41 (telephoto edge)
Half angle of view (ω)=53.02 (wide angle edge) to 6.77 (telephoto edge)
Focal length of first lens group G₃₁ (f1)=−8.72
Focal length of second lens group G₃₂ (f2)=13.62
Focal length of third lens group G₃₃ (f3)=20.13
Zoom ratio=7.88
(Lens data)
r₁=95.832

d₁=0.50 nd₁=1.88 υd₁=40.81

r₂=9.500

d₂=3.14

r₃=19.545

d₃=0.50 nd₂=1.74 υd₂=49.22

r₄=10.200

d₄=1.77

r₅=28.685 (aspheric)

d₅=4.02 nd₃=1.82 υd₃=24.06

r₆=−22.559

d₆=0.57

r₇=−16.524

d₇=0.50 nd₄=1.62 υd₄=63.86

r₈=39.439 (aspheric)

d₈=D(8) (variable)

r₉=10.268 (aspheric)

d₉=4.68 nd₅=1.50 υd₅=81.56

r₁₀=−22.386 (aspheric)

d₁₀=0.71

r₁₁=∞ (aperture stop)

d₁₁=1.57

r₁₂=14.513

d₁₂=0.60 nd₆=1.90 υd₆=31.01

r₁₃=7.283

d₁₃=4.62 nd₇=1.44 υd₇=95.10

r₁₄−37.400

d₁₄=D(14) (variable)

r₁₅=−11.084

d₁₅=0.50 nd₈=1.70 υd₈=41.15

r₁₆=10.957

d₁₆=0.66

r₁₇=16.980

d₁₇=1.84 nd₉=1.88 υd₉=40.81

r₁₈=−21.649

d₂₁=0.50

r₁₉=53.019 (aspheric)

d₁₉=2.56 nd₁₀=1.50 υd₁₀=81.56

r₂₀=−9.689 (aspheric)

d₂₀=D(20) (variable)

r₂₁=∞

d₂₁=1.50 nd₁₁=1.52 υd₁₁=64.20

r₂₂=∞

d₂₂=4.00

r₂₃=∞ (image plane)
Constant of the cone (k) and aspheric coefficients (A, B, C, D, E)
(Fifth order)
k=0,

### A=0,

B=1.40806×10⁻⁵, C=3.25534×10⁻⁶,
D=−4.17170×10⁻⁸, E=6.04485×10⁻¹⁰
(Eighth order)
k=0,

### A=0,

B=−1.81784×10⁻⁴, C=1.95668×10⁻⁶,
D=−1.62257×10⁻⁸, E=5.45870×10⁻¹¹
(Ninth order)
k=0,

### A=0,

B=−1.20860×10⁻⁴, C=−1.52404×10⁶,
D=3.61163×10⁻⁸, E=−5.39050×10⁻¹⁰
(Tenth order)
k=0,

### A=0,

B=1.00026×10⁻⁴, C=−1.20395×10⁻⁶,
D=2.99744×10⁻⁸, E=−3.95433×10⁻¹⁰
(Nineteenth order)
k=0,

### A=0,

B=4.25522×10⁻⁴, C=2.39298×10⁻⁵,
D=3.22213×10⁻⁷, E=3.18531×10⁻⁸
(Twentieth order)
k=0,

### A=0,

B=6.35974×10⁻⁴, C=6.79239×10⁻⁵,
D=−3.88398×10⁻⁶, E=1.94713×10⁻⁷
(Zoom data)

| | Wide angle edge | Telephoto edge |
|---|---|---|
| D(8) | 30.55 | 1.12 |
| D(14) | 2.17 | 38.62 |
| D(20) | 1.50 | 0.51 |

(Values related to conditional expression (1))

|β2T/β2W|=7.46

β2T: Magnification of second lens group G₃₂ at telephoto edge
β2W: Magnification of second lens group G₃₂ at wide angle edge
(Values related to conditional expression (2))

β2W=−0.40

(Values related to conditional expression (3))

β2T=−2.99

(Values related to conditional expression (4))

βLT=0.93

βLT: Magnification of lens group (third lens group G₃₃) disposed farthest on image side, at telephoto edge
(Values related to conditional expression (5))

|f1|/f2=0.64

(Values related to conditional expression (0)

|f2/f3|=0.68

(Values related to conditional expression (7))

υd1p=24.06

υd1p: Abbe number for d-line of positive lens (positive lens L₃₁₃) included in first lens group G₃₁
(Values related to conditional expression (8))

υd1n=63.86

υd1n: Abbe number for d-line of negative lens (negative lens L₃₁₄) included in first lens group G₃₁
(Values related to conditional expression (9))

υd2pa=88.33

υd2pa: Average value of Abbe number for d-line of positive lenses included in second lens group G₃₂
(Values related to conditional expression (10))

(R31+R32)/(R31−R32)=0.04

R31: Radius of curvature of surface on object side of negative lens L₃₃₁ disposed farthest on object side of third lens group G₃₃
R32: Radius of curvature of surface on image side of negative lens L₃₃₁ disposed farthest on object side of third lens group G₃₃
(Values related to conditional expression (11))

|X2|²/(|f1|×f2)=10.59

X2: Distance that second lens group G₃₂ is moved during zooming from wide angle edge to telephoto edge (=39.46)
(Values related to conditional expression (12))

f2/fLw=0.68

fLw: Composite focal length of third lens group G₃₃ and all lens groups disposed thereafter, at wide angle edge

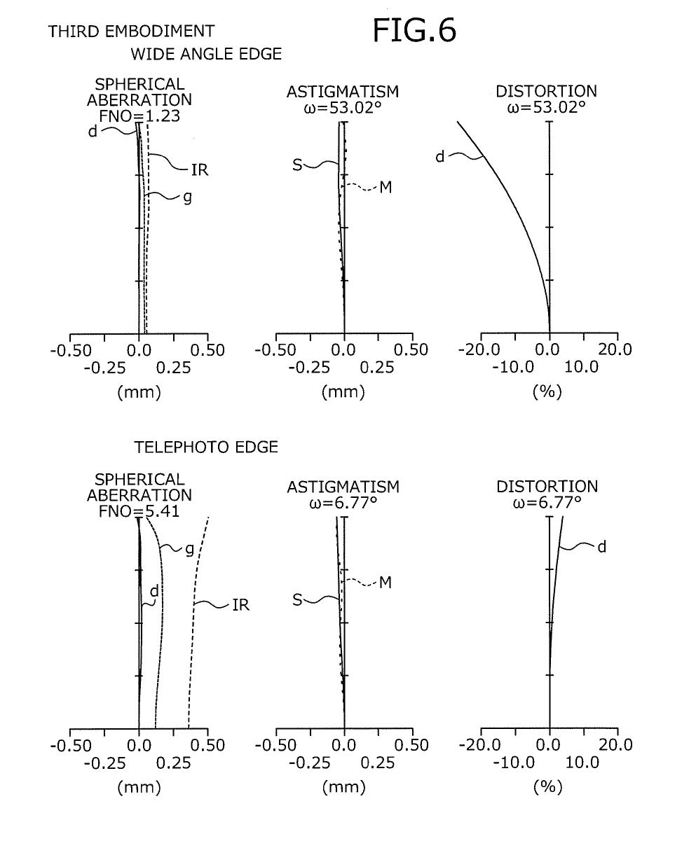

FIG. 6 is a diagram of various types of aberration occurring in the zoom lens according to the third embodiment. In the diagram, for curves depicting spherical aberration, the vertical axis represents the F number (FNO), solid lines depict wavelength characteristics corresponding to the d-line (λ=587.56 nm), dotted lines depict wavelength characteristics corresponding to the g-line (λ=435.84 nm), and dashed lines depict wavelength characteristics corresponding to IR rays (λ=850.00 nm). For curves depicting astigmatism, the vertical axis represents the half angle of view (ω) and wavelength characteristics corresponding to d-line are depicted, where solid lines depict characteristics of the sagittal plane (S), and dashed lines depict characteristics of the meridonal plane (M). For curves depicting distortion, the vertical axis represents the half angle of view (ω), and wavelength characteristics corresponding to d-line are depicted.

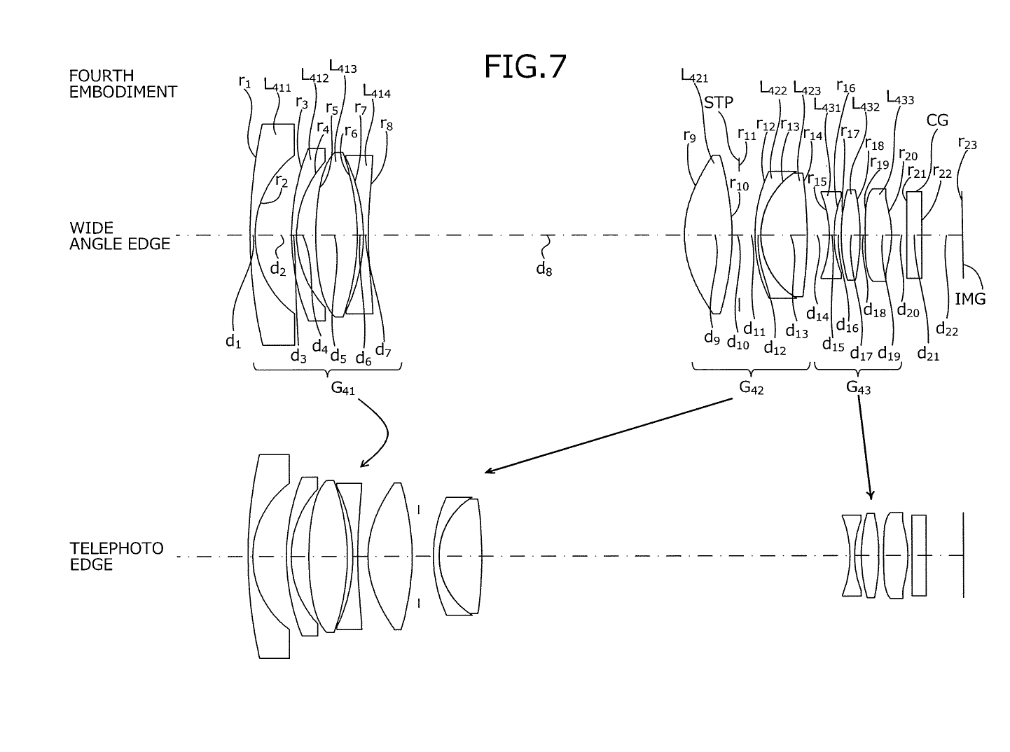

FIG. 7 is a diagram depicting, along the optical axis, a configuration of the zoom lens according to a fourth embodiment. The zoom lens is configured to include sequentially from the object side nearest a non-depicted object, a first lens group G₄₁ having a negative refractive power, a second lens group G₄₂ having a positive refractive power, and a third lens group G₄₃ having a positive refractive power. The cover glass CG is disposed between the third lens group G₄₃ and the image plane IMG.

The first lens group G₄₁ is configured to include sequentially from the object side, a negative lens L₄₁₁, a negative lens L₄₁₂, a positive lens L₄₁₃, and a negative lens L₄₁₄. The positive lens L₄₁₃ has an aspheric surface on the object side. The negative lens L₄₁₄ has an aspheric surface on the image plane IMG side.

The second lens group G₄₂ is configured to include sequentially from the object side, a positive lens L₄₂₁, the aperture stop STP prescribing a given aperture, a negative lens L₄₂₂, and a positive lens L₄₂₃. Both surfaces of the positive lens L₄₂₁ are aspheric. The negative lens L₄₂₂ and the positive lens L₄₂₃ are cemented.

The third lens group G₄₃ is configured to include sequentially from the object side, a negative lens L₄₃₁, a positive lens L₄₃₂, and a positive lens L₄₃₃. The negative lens L₄₃₁ has a concave surface on the object side. Both surfaces of the positive lens L₄₃₃ are aspheric.

The zoom lens moves the first lens group G₄₁ along the optical axis, to form on the image plane IMG side, a convex locus and thereby, performs zooming from the wide angle edge to the telephoto edge. Further, the zoom lens moves the second lens group G₄₂ along the optical axis, from the image plane IMG side toward the object side and moves the third lens group G₄₃ along the optical axis, from the object side toward the image plane IMG side and thereby, corrects the position of the image plane IMG accompanying zooming. During correction, the aperture stop STP moves together with the second lens group G₄₂. The zoom lens further moves the first lens group G₄₁ along the optical axis, toward the object side to perform focusing from a focused state at infinity to a focused state at the minimum object distance.

Here, values of various types of data related to the zoom lens according to the fourth embodiment are given.

Focal length of entire zoom lens=3.09 (wide angle edge) to 25.28 (telephoto edge)
F number (FNO)=1.24 (wide angle edge) to 5.59 (telephoto edge)
Half angle of view (ω)=51.14 (wide angle edge) to 6.52 (telephoto edge)
Focal length of first lens group G₄₁ (f1)=−8.88
Focal length of second lens group G₄₂ (f2)=13.73
Focal length of third lens group G₄₃ (f3)=19.12
Zoom ratio=8.19
(Lens data)
r₁=46.713

d₁=0.50 nd₁=1.88 υd₁=40.81

r₂=9.500

d₂=3.66

r₃=21.676

d₃=0.50 nd₂=1.74 υd₂=49.22

r₄=10.262

d₄=1.91

r₅=27.990 (aspheric)

d₅=4.13 nd₃=1.82 υd₃=24.06

r₆=−23.453

d₆=0.61

r₇=−16.902

d₇=0.50 nd₄=1.62 υd₄=63.86

r₈=34.085 (aspheric)

d₈=D(8) (variable)

r₉=10.227 (aspheric)

d₉=4.75 nd₅=1.50 υd₅=81.56

r₁₀=−22.296 (aspheric)

d₁₀=0.71

r₁₁=∞ (aperture stop)

d₁₁=1.57

r₁₂=14.438

d₁₂=0.60 nd₆=1.90 υd₆=31.01

r₁₃=7.228

d₁₃=4.59 nd₇=1.44 υd₇=95.10

r₁₄=−43.169

d₁₄=D(14) (variable)

r₁₅=−11.021

d₁₅=0.50 nd₈=1.70 υd₈=41.15

r₁₆=10.104

d₁₆=0.72

r₁₇=16.174

d₁₇=1.87 nd₉=1.88 υd₉=40.81

r₁₈=−21.359

d₁₈=0.50

r₁₉=52.774 (aspheric)

d₁₉=2.62 nd₁₀=1.50 υd₁₀=81.56

r₂₀=−9.309 (aspheric)

d₂₀=D(20) (variable)

r₂₁=∞

d₂₁=1.50 nd₁₁=1.52 υd₁₁=64.20

r₂₂=∞

d₂₂=4.00r₂₃=∞ (image plane)

Constant of the cone (k) and aspheric coefficients (A, B, C, D, E)
(Fifth order)
k=0,

### A=0,

B=−4.22974×10⁻⁶, C=3.00580×10⁻⁶,
D=−3.72775×10⁻⁸, E=5.19830×10⁻¹⁰
(Eighth order)
k=0,

### A=0,

B=−1.96237×10⁻⁴, C=1.99541×10⁻⁶,
D=−1.40593×10⁻⁸, E=3.63024×10⁻¹¹
(Ninth order)
k=0,

### A=0,

B=−1.22444×10⁻⁴, C=−1.45093×10⁻⁶,
D=3.34444×10⁻⁸, E=−5.05995×10⁻¹⁰
(Tenth order)
k=0,

### A=0,

B=9.71687×10⁻⁵, C=−1.08483×10⁻⁶,
D=2.66175×10⁸, E=−3.52297×10⁻¹⁰
(Nineteenth order)
k=0,

### A=0,

B=3.62043×10⁻⁴, C=2.31518×10⁻⁵,
D=2.37504×10⁻⁷, E=3.55302×10⁻⁸
(Twentieth order)
k=0,

### A=0,

B=5.38706×10⁻⁴, C=6.98508×10⁻⁵,
D=−4.18158×10⁻⁶, E=1.96092×10⁻⁷
(Zoom data)

| | Wide angle edge | Telephoto edge |
|---|---|---|
| D(8) | 31.53 | 1.13 |
| D(14) | 2.20 | 39.68 |
| D(20) | 1.50 | 0.45 |

(Values related to conditional expression (1))

|β2T/β2W|=7.71

β2T: Magnification of second lens group G₄₂ at telephoto edge
β2W: Magnification of second lens group G₄₂ at wide angle edge
(Values related to conditional expression (2))

β2W=−0.39

(Values related to conditional expression (3))

β2T=−3.03

(Values related to conditional expression (4))

βLT=0.94

βLT: Magnification of lens group (third lens group G₄₃) disposed farthest on image side, at telephoto edge
(Values related to conditional expression (5))

|f1|/f2=0.65

(Values related to conditional expression (6))

|f2/f3|=0.72

(Values related to conditional expression (7))

υd1p=24.06

υd1p: Abbe number for d-line of positive lens (positive lens L₄₁₃) included in first lens group G₄₁
(Values related to conditional expression (8))

υd1n=63.86

υd1n: Abbe number for d-line of negative lens (negative lens L₄₁₄) included in first lens group G₄₁
(Values related to conditional expression (9))

υd2pa=88.33

υd2pa: Average value of Abbe number for d-line of positive lenses included in second lens group G₄₂
(Values related to conditional expression (10))

(R31+R32)/(R31−R32)=0.04

R31: Radius of curvature of surface on object side of negative lens L₄₃₁ disposed farthest on object side of third lens group G₄₃
R32: Radius of curvature of surface on image side of negative lens L₄₃₁ disposed farthest on object side of third lens group G₄₃
(Values related to conditional expression (11))

|X2|²/(|f1|×f2)=10.88

X2: Distance that second lens group G₄₂ is moved during zooming from wide angle edge to telephoto edge (=36.43)
(Values related to conditional expression (12))

f2/fLw=0.72

fLw: Composite focal length of third lens group G₄₃ and all lens groups disposed thereafter, at wide angle edge

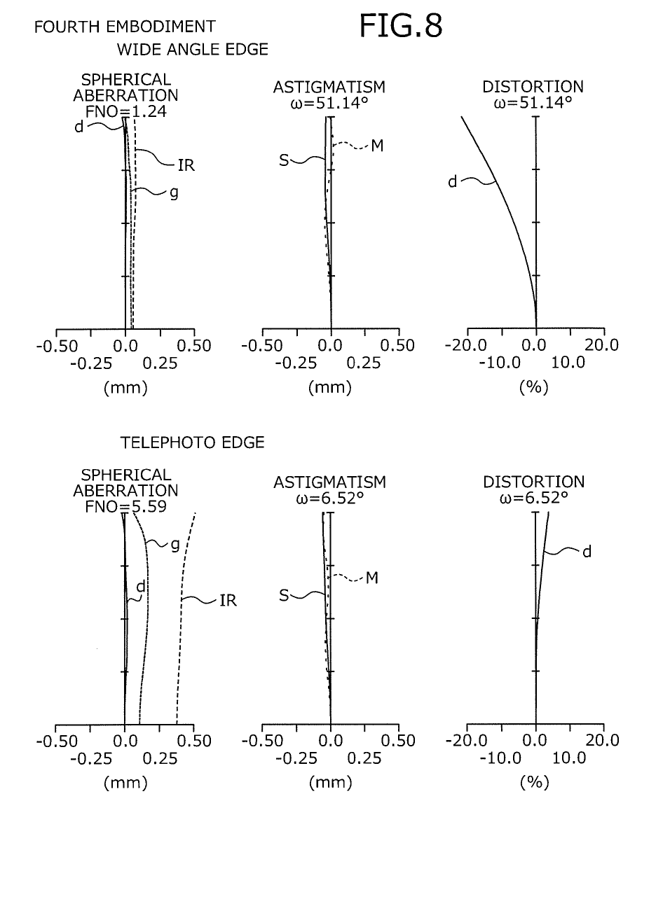

FIG. 8 is a diagram of various types of aberration occurring in the zoom lens according to the fourth embodiment. In the diagram, for curves depicting spherical aberration, the vertical axis represents the F number (FNO), solid lines depict wavelength characteristics corresponding to the d-line (λ=587.56 nm), dotted lines depict wavelength characteristics corresponding to the g-line (λ=435.84 nm), and dashed lines depict wavelength characteristics corresponding to IR rays (λ=850.00 nm). For curves depicting astigmatism, the vertical axis represents the half angle of view (ω) and wavelength characteristics corresponding to d-line are depicted, where solid lines depict characteristics of the sagittal plane (S), and dashed lines depict characteristics of the meridonal plane (M). For curves depicting distortion, the vertical axis represents the half angle of view (ω), and wavelength characteristics corresponding to d-line are depicted.

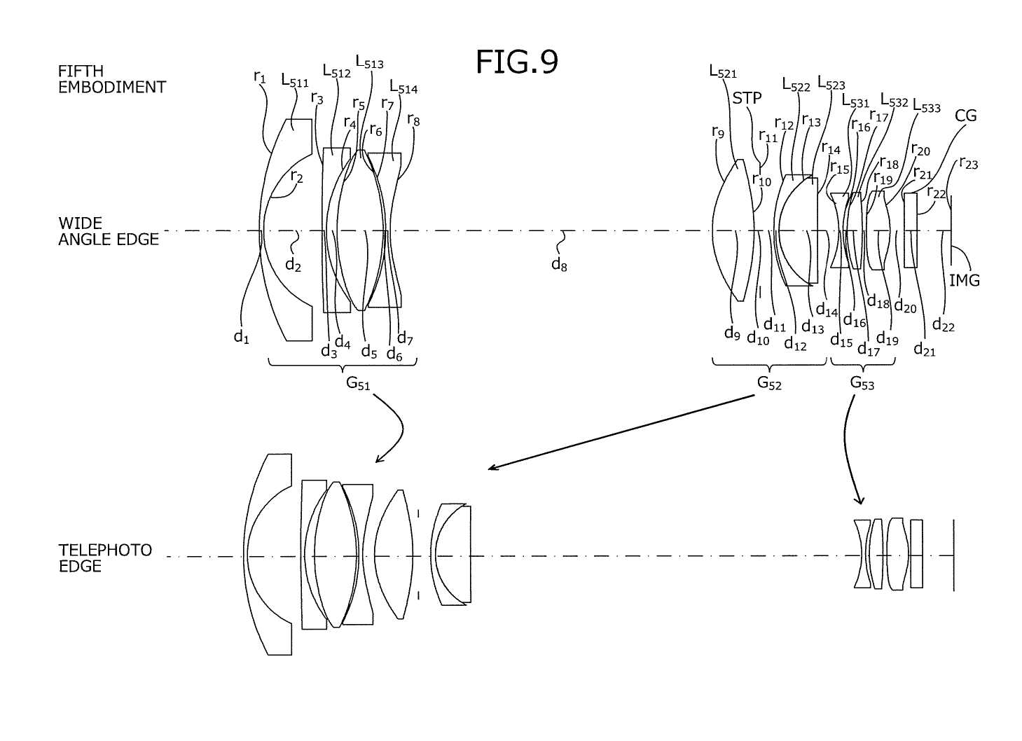

FIG. 9 is a diagram depicting, along the optical axis, a configuration of the zoom lens according to a fifth embodiment. The zoom lens is configured to include sequentially from the object side nearest a non-depicted object, a first lens group G₅₁ having a negative refractive power, a second lens group G₅₂ having a positive refractive power, and a third lens group G₅₃ having a positive refractive power. The cover glass CG is disposed between the third lens group G₅₃ and the image plane IMG.

The first lens group G₅₁ is configured to include sequentially from the object side, a negative lens L₅₁₁, a negative lens L₅₁₂, a positive lens L₅₁₃, and a negative lens L₅₁₄. The positive lens L₅₁₃ has an aspheric surface on the object side. The negative lens L₅₁₄ has an aspheric surface on the image plane IMG side.

The second lens group G₅₂ is configured to include sequentially from the object side, a positive lens L₅₂₁, the aperture stop STP prescribing a given aperture, a negative lens L₅₂₂, and a positive lens L₅₂₃. Both surfaces of the positive lens L₅₂₁ are aspheric. The negative lens L₅₂₂ and the positive lens L₅₂₃ are cemented.

The third lens group G₅₃ is configured to include sequentially from the object side, a negative lens L₅₃₁, a positive lens L₅₃₂, and a positive lens L₅₃₃. The negative lens L₅₃₁ has a concave surface on the object side. Both surfaces of the positive lens L₅₃₃ are aspheric.

The zoom lens moves the first lens group G₅₁ along the optical axis, to form on the image plane IMG side, a convex locus and thereby, performs zooming from the wide angle edge to the telephoto edge. Further, the zoom lens moves the second lens group G₅₂ along the optical axis, from the image plane IMG side toward the object side and moves the third lens group G₅₃ along the optical axis, to form on the object side, a gradual convex locus and thereby, corrects the position of the image plane IMG accompanying zooming. During correction, the aperture stop STP moves together with the second lens group G₅₂. The zoom lens further moves the first lens group G₅₁ along the optical axis, toward the object side to perform focusing from a focused state at infinity to a focused state at the minimum object distance.

Here, values of various types of data related to the zoom lens according to the fifth embodiment are given.

Focal length of entire zoom lens=3.09 (wide angle edge) to 31.14 (telephoto edge)
F number (FNO)=1.23 (wide angle edge) to 6.50 (telephoto edge)
Half angle of view (ω)=55.16 (wide angle edge) to 5.71 (telephoto edge)
Focal length of first lens group G₅₁ (f1)=−9.90
Focal length of second lens group G₅₂ (f2)=14.96
Focal length of third lens group G₅₃ (f3)=19.46
Zoom ratio=10.09
(Lens data)
r₁=26.825

d₁=0.50 nd₁=1.88 υd₁=40.81

r₂=9.500

d₂=6.87

r₃=283.853

d₃=0.50 nd₂=1.64 υd₂=55.45

r₄=13.341

d₄=1.24

r₅=18.652 (aspheric)

d₅=5.37 nd₃=1.90 υd₃=31.01

r₆=−20.586

d₆=0.32

r₇=−18.586

d₇=0.50 nd₄=1.62 υd₄=63.86

r₈=14.772 (aspheric)

d₈=D(8) (variable)

r₉=10.932 (aspheric)

d₉=4.89 nd₅=1.50 υd₅=81.56

r₁₀=−22.740 (aspheric)

d₁₀=0.71

r₁₁=∞ (aperture stop)

d₂₁=1.57

r₁₂=15.124

d₁₂=0.60 nd₆=1.80 υd₆=29.84

r₁₃=7.157

d₁₃=4.47 nd₇=1.44 υd₇=95.10

r₁₄=415.217

d₁₄=D(14) (variable)

r₁₅=−9.835

d₁₅=0.50 nd₈=1.62 υd₈=36.30

r₁₆=11.290

d₁₆=0.47

r₁₇=14.063

d₁₇=1.75 nd₉=1.85 υd₉=32.27

r₁₈=−48.539

d₁₈=0.50

r₁₉=51.226 (aspheric)

d₁₉=2.76 nd₁₀=1.50 υd₁₀=81.56

r₂₀=−7.918 (aspheric)

d₂₀=D(20) (variable)

r₂₁=∞

d₂₁=1.50 nd₁₁=1.52 υd₁₁=64.20

r₂₂=∞

d₂₂=4.00r₂₃=∞ (image plane)

Constant of the cone (k) and aspheric coefficients (A, B, C, D, E)
(Fifth order)
k=0,

### A=0,

B=−1.08363×10⁻⁴, C=1.59004×10⁻⁶,
D=−1.70725×10⁻⁸, E=1.67325×10⁻¹⁰
(Eighth order)
k=0,

### A=0,

B=−3.13596×10⁻⁴, C=2.52792×10⁻⁶,
D=−3.21565×10⁻⁸, E=2.34769×10⁻¹⁰
(Ninth order)
k=0,

### A=0,

B=−1.02452×10⁻⁴, C=−5.67217×10⁻⁷,
D=6.25623×10⁹, E=−1.12478×10⁻¹⁰
(Tenth order)
k=0,

### A=0,

B=6.90491×10⁻⁵, C=−4.62562×10⁻⁷,
D=9.12845×10⁻⁹, E=−8.83652×10⁻¹¹
(Nineteenth order)
k=0,

### A=0,

B=3.19106×10⁻⁴, C=1.97993×10⁻⁵,
D=1.84618×10⁻⁷, E=3.07653×10⁻⁸
(Twentieth order)
k=0,

### A=0,

B=7.27355×10⁻⁴, C=5.37611×10⁻⁵,
D=−3.02061×10⁻⁶, E=1.47278×10⁻⁷
(Zoom data)

| | Wide angle edge | Telephoto edge |
|---|---|---|
| D(8) | 37.74 | 1.49 |
| D(14) | 2.54 | 50.18 |
| D(20) | 1.65 | 0.29 |

(Values related to conditional expression (1))

|β2T/β2W|=9.33

β2T: Magnification of second lens group G₅₂ at telephoto edge
β2W: Magnification of second lens group G₅₂ at wide angle edge
(Values related to conditional expression (2))

β2W=−0.37

(Values related to conditional expression (3))

β2T=−3.44

(Values related to conditional expression (4))

βLT=0.92

βLT: Magnification of lens group (third lens group G₅₃) disposed farthest on image side, at telephoto edge
(Values related to conditional expression (5))

|f1|/f2=0.66

(Values related to conditional expression (6))

|f2/f3|=0.77

(Values related to conditional expression (7))

υd1p=31.01

υd1p: Abbe number for d-line of positive lens (positive lens L₅₁₃) included in first lens group G₅₁
(Values related to conditional expression (8))

υd1n=63.86

υd1n: Abbe number for d-line of negative lens (negative lens L₅₁₄) included in first lens group G₅₁
(Values related to conditional expression (9))

υd2pa=88.33

υd2pa: Average value of Abbe number for d-line of positive lens included in second lens group G₅₂
(Values related to conditional expression (10))

(R31+R32)/(R31−R32)=−0.07

R31: Radius of curvature of surface on object side of negative lens L₅₃₁ disposed farthest on object side of third lens group G₅₃
R32: Radius of curvature of surface on image side of negative lens L₅₃₁ disposed farthest on object side of third lens group G₅₃
(Values related to conditional expression (11))

|X2|²/(|f1|×f2)=14.46

X2: Distance that second lens group G₅₂ is moved during zooming from wide angle edge to telephoto edge (=46.27)
(Values related to conditional expression (12))

f2/fLw=0.77

fLw: Composite focal length of third lens group G₅₃ and all lens groups disposed thereafter, at wide angle edge

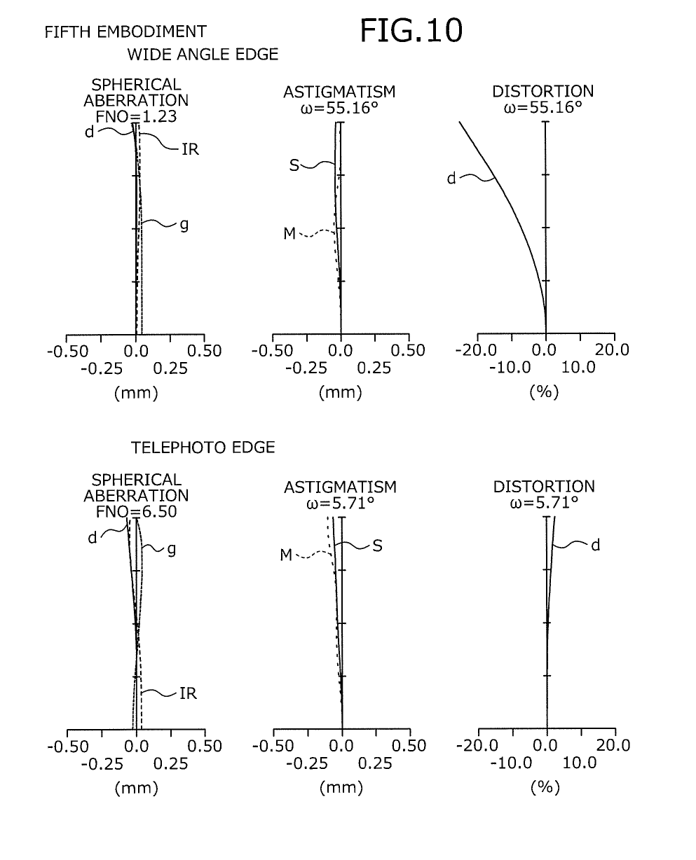

FIG. 10 is a diagram of various types of aberration occurring in the zoom lens according to the fifth embodiment. In the diagram, for curves depicting spherical aberration, the vertical axis represents the F number (FNO), solid lines depict wavelength characteristics corresponding to the d-line (λ=587.56 nm), dotted lines depict wavelength characteristics corresponding to the g-line (λ=435.84 nm), and dashed lines depict wavelength characteristics corresponding to IR rays (λ=850.00 nm). For curves depicting astigmatism, the vertical axis represents the half angle of view (ω) and wavelength characteristics corresponding to d-line are depicted, where solid lines depict characteristics of the sagittal plane (S), and dashed lines depict characteristics of the meridonal plane (M). For curves depicting distortion, the vertical axis represents the half angle of view (ω), and wavelength characteristics corresponding to d-line are depicted.

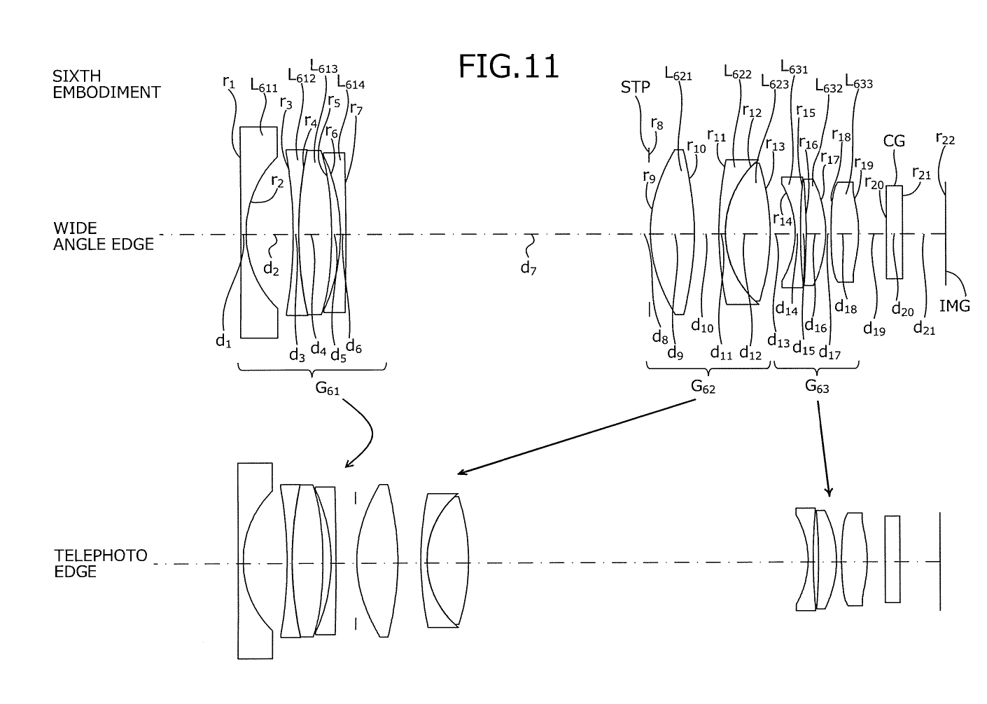

FIG. 11 is a diagram depicting, along the optical axis, a configuration of the zoom lens according to a sixth embodiment. The zoom lens is configured to include sequentially from the object side nearest a non-depicted object, a first lens group G₆₁ having a negative refractive power, a second lens group G₆₂ having a positive refractive power, and a third lens group G₆₃ having a positive refractive power. The cover glass CG is disposed between the third lens group G₆₃ and the image plane IMG.

The first lens group G₆₁ is configured to include sequentially from the object side, a negative lens L₆₁₁, a negative lens L₆₁₂, a positive lens L₆₁₃, and a negative lens L₆₁₄. The negative lens L₆₁₂ and the positive lens L₆₁₃ are cemented. The positive lens L₆₁₃ has an aspheric surface on the image plane IMG side.

The second lens group G₆₂ is configured to include sequentially from the object side, the aperture stop STP prescribing a given aperture, a positive lens L₆₂₁, a negative lens L₆₂₂, and a positive lens L₆₂₃. Both surfaces of the positive lens L₆₂₁ are aspheric. The negative lens L₆₂₂ and the positive lens L₆₂₃ are cemented.

The third lens group G₆₃ is configured to include sequentially from the object side, a negative lens L₆₃₁, a positive lens L₆₃₂, and a positive lens L₆₃₃. The negative lens L₆₃₁ has a concave surface on the object side. Both surfaces of the positive lens L₆₃₃ are aspheric.

The zoom lens moves the first lens group G₆₁ along the optical axis, to form on the image plane IMG side, a convex locus and thereby, performs zooming from the wide angle edge to the telephoto edge. Further, the zoom lens moves the second lens group G₆₂ along the optical axis, from the image plane IMG side toward the object side and moves the third lens group G₆₃ along the optical axis, from the object side toward the image plane IMG side and thereby, corrects the position of the image plane IMG accompanying zooming. During correction, the aperture stop STP moves together with the second lens group G₆₂. The zoom lens further moves the first lens group G₆₁ along the optical axis, toward the object side to perform focusing from a focused state at infinity to a focused state at the minimum object distance.

Here, values of various types of data related to the zoom lens according to the sixth embodiment are given.

Focal length of entire zoom lens=3.19 (wide angle edge) to 19.44 (telephoto edge)
F number (FNO)=1.23 (wide angle edge) to 3.46 (telephoto edge)
Half angle of view (ω)=63.45 (wide angle edge) to 9.03 (telephoto edge)
Focal length of first lens group G₆₁ (f1)=−8.87
Focal length of second lens group G₆₂ (f2)=14.15
Focal length of third lens group G₆₃ (f3)=20.70
Zoom ratio=6.09
(Lens data)
r₁=−1214.004

d₁=0.50 nd₁=1.90 υd₁=37.37

r₂=9.500

d₂=4.39

r₃=−41.362

d₃=0.50 nd₂=1.62 υd₂=60.34

r₄=34.311

d₄=3.06 nd₃=1.92 υd₃=20.88

r₅=−38.697 (aspheric)

d₅=0.82

r₆=−16.500

d₆=0.50 nd₄=1.50 υd₄=81.56

r₇=−276.937

d₇=D (7) (variable)

r₈=∞ (aperture stop)

d₈=0.10

r₉=11.908 (aspheric)

d₉=4.09 nd₅=1.55 υd₅=71.68

r₁₀=−23.716 (aspheric)

d₁₀=2.28

r₁₁=31.163

d₁₁=0.60 nd₆=1.74 υd₆=32.26

r₁₂=8.502

d₁₂=4.13 nd₇=1.44 υd₇=95.10

r₁₃=−20.456

d₁₃=D(13) (variable)

r₁₄=−8.639

d₁₄=0.50 nd₈=1.52 υd₈=52.15

r₁₅=49.450

d₁₅=0.53

r₁₆=−56.822

d₁₆=1.83 nd₉=1.55 υd₉=71.68

r₁₇=−10.549

d₁₇=0.50

r₁₈=37.725 (aspheric)

d₁₈=2.56 nd₁₀=1.50 υd₁₀=81.56r

D₁₉−10.893 (aspheric)

d₁₉=D(19) (variable)

r₂₀=∞

d₂₀=1.50 nd₁₁=1.52 υd₁₁=64.20

r₁₁=∞

d₂₁=4.00

r₂₂=∞ (image plane)
Constant of the cone (k) and aspheric coefficients (A, B, C, D, E)
(Fifth order)
k=0,

### A=0,

B=−6.43049×10⁻⁵, C=−3.13937×10⁻⁷,
D=7.90770×10⁻¹⁰, E=−2.56196×10⁻¹¹
(Ninth order)
k=0,

### A=0,

B=−9.58017×10⁻⁵, C=−5.28701×10⁻⁷,
D=2.20174×10⁻⁸, E=−3.25046×10⁻¹⁰
(Tenth order)
k=0,

### A=0,

B=9.23714×10⁻⁵, C=−7.68271×10⁷,
D=2.53988×10⁸, E=−3.43261×10⁻¹⁰
(Eighteenth order)
k=0,

### A=0,

B=2.09121×10⁻⁴, C=1.63339×10⁻⁵,
D=1.84981×10⁻⁸, E=2.83988×10⁻⁸
(Nineteenth order)
k=0,

### A=0,

B=4.45201×10⁻⁴, C=3.75015×10⁻⁵,
D=−1.86997×10⁻⁶, E=9.73204×10⁻⁸
(Zoom data)

| | Wide angle edge | Telephoto edge |
|---|---|---|
| D(7) | 28.19 | 1.95 |
| D(13) | 2.30 | 33.89 |
| D(19) | 2.58 | 1.76 |

(Values related to conditional expression (1))

|β2T/β2W|=5.82

β2T: Magnification of second lens group G₆₂ at telephoto edge
β2W: Magnification of second lens group G₆₂ at wide angle edge
(Values related to conditional expression (2))

β2W=−0.45

(Values related to conditional expression (3))

β2T=−2.60

(Values related to conditional expression (4))

βLT=0.84

βLT: Magnification of lens group (third lens group G₆₃) disposed farthest on image side, at telephoto edge
(Values related to conditional expression (5))

|f1|/f2=0.63

(Values related to conditional expression (6))

|f2/f3|=0.68

(Values related to conditional expression (7))

υd1p=20.88

υd1p: Abbe number for d-line of positive lens (positive lens L₆₁₃) included in first lens group G₆₁
(Values related to conditional expression (8))

υd1n=81.56

υd1n: Abbe number for d-line of negative lens (negative lens L₆₁₄) included in first lens group G₆₁
(Values related to conditional expression (9))

υd2pa=83.39

υd2pa: Average value of Abbe number for d-line of positive lenses included in second lens group G₆₂
(Values related to conditional expression (10))

(R31+R32)/(R31−R32)=−0.70

R31: Radius of curvature of surface on object side of negative lens L₆₃₁ disposed farthest on object side of third lens group G₆₃
R32: Radius of curvature of surface on image side of negative lens L₆₃₁ disposed farthest on object side of third lens group G₆₃
(Values related to conditional expression (11))

|X2|²/(|f1|×f2)=7.55

X2: Distance that second lens group G₆₂ is moved during zooming from wide angle edge to telephoto edge (=30.78)
(Values related to conditional expression (12))

f2/fLw=0.68

fLw: Composite focal length of third lens group G₆₃ and all lens groups disposed thereafter, at wide angle edge

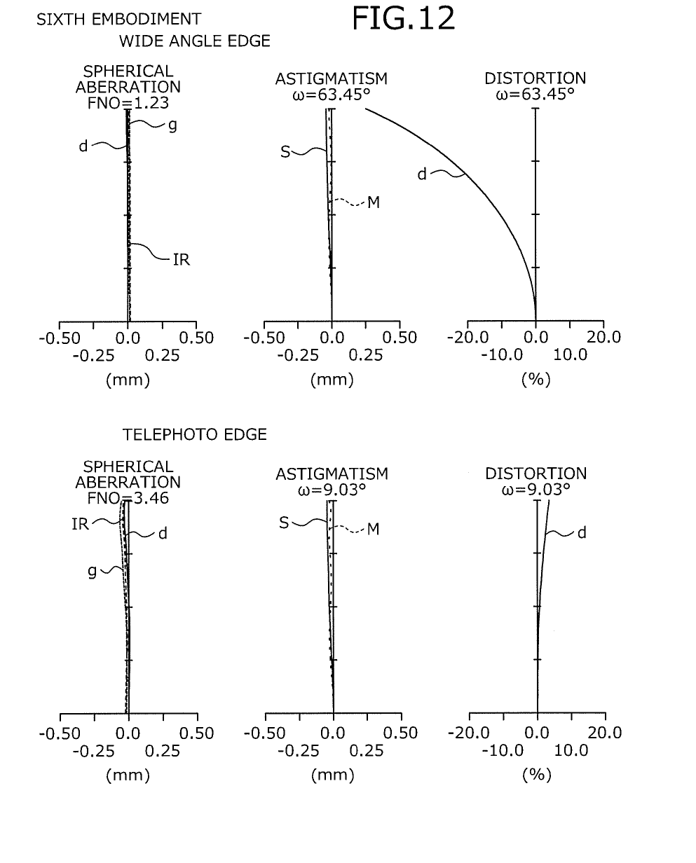

FIG. 12 is a diagram of various types of aberration occurring in the zoom lens according to the sixth embodiment. In the diagram, for curves depicting spherical aberration, the vertical axis represents the F number (FNO), solid lines depict wavelength characteristics corresponding to the d-line (λ=587.56 nm), dotted lines depict wavelength characteristics corresponding to the g-line (λ=435.84 nm), and dashed lines depict wavelength characteristics corresponding to IR rays (λ=850.00 nm). For curves depicting astigmatism, the vertical axis represents the half angle of view (a) and wavelength characteristics corresponding to d-line are depicted, where solid lines depict characteristics of the sagittal plane (S), and dashed lines depict characteristics of the meridonal plane (M). For curves depicting distortion, the vertical axis represents the half angle of view (ω), and wavelength characteristics corresponding to d-line are depicted.

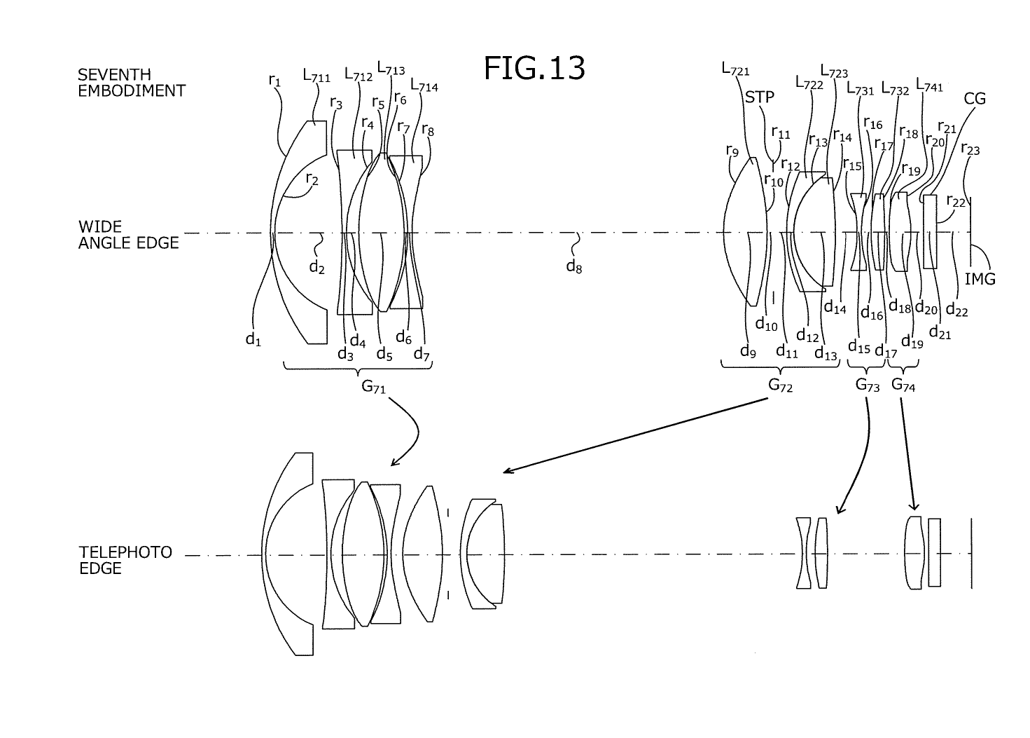

FIG. 13 is a diagram depicting, along the optical axis, a configuration of the zoom lens according to a seventh embodiment. The zoom lens is configured to include sequentially from the object side nearest a non-depicted object, a first lens group G₇₁ having a negative refractive power, a second lens group G₇₂ having a positive refractive power, a third lens group G₇₃ having a negative refractive power, and fourth lens group G₇₄ a having a positive refractive power. The cover glass CG is disposed between the fourth lens group G₇₄ and the image plane IMG.

The first lens group G₇₁ is configured to include sequentially from the object side, a negative lens L₇₁₁, a negative lens L₇₁₂, a positive lens L₇₁₃, and a negative lens L₇₁₄. The positive lens L₇₁₃ has an aspheric surface on the object side. The negative lens L₇₁₄ has an aspheric surface on the image plane IMG side.

The second lens group G₇₂ is configured to include sequentially from the object side, a positive lens L₇₂₁, the aperture stop STP prescribing a given aperture, a negative lens L₇₂₂, and a positive lens L₇₂₃. Both surfaces of the positive lens L₇₂₁ are aspheric. The negative lens L₇₂₂ and the positive lens L₇₂₃ are cemented.

The third lens group G₇₃ is configured to include sequentially from the object side, a negative lens L₇₃₁ and a positive lens L₇₃₂. The negative lens L₇₃₁ has a concave surface on the object side.

The fourth lens group G₇₄ is configured by a positive lens L₇₄₁. Both surfaces of the positive lens L₇₄₁ are aspheric.

The zoom lens moves the first lens group G₇₁ along the optical axis, to form on the image plane IMG side, a convex locus and thereby, performs zooming from the wide angle edge to the telephoto edge. Further, the zoom lens moves the second lens group G₇₂ along the optical axis, from the image plane IMG side toward the object side and moves the third lens group G₇₃ along the optical axis, to form on the image plane IMG side, a gradual convex locus and further moves the fourth lens group G₇₄ along the optical axis, from the object side toward the image plane IMG to correct the position of the image plane IMG accompanying zooming. During correction, the aperture stop STP moves together with the second lens group G₇₂. The zoom lens further moves the first lens group G₇₁ along the optical axis, toward the object side to perform focusing from a focused state at infinity to a focused state at the minimum object distance.

Here, values of various types of data related to the zoom lens according to the seventh embodiment are given.

Focal length of entire zoom lens=3.09 (wide angle edge) to 31.12 (telephoto edge)
F number (FNO)=1.23 (wide angle edge) to 6.88 (telephoto edge)
Half angle of view (ω)=52.03 (wide angle edge) to 5.41 (telephoto edge)
Focal length of first lens group G₇₁ (f1)=−9.07
Focal length of second lens group G₇₂ (f2)=14.59
Focal length of third lens group G₇₃ (f3)=−34.24
Focal length of fourth lens group G₇₄=17.08
Zoom ratio=10.08
(Lens data)
r₁=20.859

d₁=0.50 nd₁=1.88 υd₁=40.81

r₂=9.500

d₂=7.87

r₃=−73.957

d₃=0.50 nd₂=1.64 υd₂=55.45

r₄=12.285

d₄=1.44

r₅=18.848 (aspheric)

d₅=5.30 nd₃=1.90 υd₃=31.01

r₆=−20.815

d₆=0.41

r₇=−17.927

d₇=0.50 nd₄=1.62 υd₄=63.86

r₈=15.963 (aspheric)

d₈=D(8) (variable)

r₉=11.414 (aspheric)

d₉=5.08 nd₅=1.50 υd₅=81.56

r₁₀=−23.827 (aspheric)

d₁₀=0.71

r₁₁=∞ (aperture stop)

d₁₁=1.57

r₁₂=16.271

d₁₂=0.83 nd₆=1.80 υd₆=29.84

r₁₃=7.720

d₁₃=4.82 nd₇=1.44 υd₇=95.10

r₁₄=−54.939

d₁₄=D(14) (variable)

r₁₅−12.976

d₁₅=0.50 nd₈=1.62 υd₈=36.30

r₁₆=12.988

d₁₆=1.13

r₁₇=19.171

d₁₇=1.59 nd₉=1.85 υd₉=32.27

r₁₈=−57.591

d₁₈=D(18) (variable)

r₁₉=41.241 (aspheric)

d₁₉=2.53 nd₁₀=1.50 υd₁₀=81.56

r₂₀=−10.474 (aspheric)

d₂₀=D(20) (variable)

r₂₁=∞

d₂₁=1.50 nd₁₁=1.52 υd₁₁=64.20

r₂₂=υ

d₂₂=4.00

r₁₁=∞ (image plane)
Constant of the cone (k) and aspheric coefficients (A, B, C, D, E)
(Fifth order)
k=0,

### A=0,

B=−1.10804×10⁻⁴, C=2.40067×10⁻⁶,
D=−2.80248×10⁻⁸, E=2.34615×10⁻¹⁰
(Eighth order)
k=0,

### A=0,

B=−3.03764×10⁻⁴, C=3.42411×10⁻⁶,
D=−4.75443×10⁻⁸, E=3.55623×10⁻¹⁰
(Ninth order)
k=0,

### A=0,

B=−9.31203×10⁵, C=−4.35845×10⁻⁷,
D=3.02696×10⁻⁹, E=−5.65335×10⁻¹¹
(Tenth order)
k=0,

### A=0,

B=7.16629×10⁻⁹, C=−5.08309×10⁻⁷,
D=7.05728×10⁻⁹, E=−5.04859×10⁻¹¹
(Nineteenth order)
k=0,

### A=0,

B=3.31171×10⁻⁴, C=2.53313×10⁻⁵,
D=7.07224×10⁻⁸, E=2.98452×10⁻⁸
(Twentieth order)
k=0,

### A=0,

B=5.29799×10⁻⁴, C=6.53044×10⁻⁹,
D=−3.34111×10⁻⁶, E=1.60775×10⁻⁷
(Zoom data)

| | Wide angle edge | Telephoto edge |
|---|---|---|
| D(8) | 36.54 | 1.51 |
| D(14) | 2.59 | 38.22 |
| D(18) | 0.53 | 9.92 |
| D(20) | 1.50 | 0.55 |

(Values related to conditional expression (1))

|β2T/β2W|=8.18

β2T: Magnification of second lens group G₇₂ at telephoto edge
β2W: Magnification of second lens group G₇₂ at wide angle edge
(Values related to conditional expression (2))

β2W=−0.37

(Values related to conditional expression (3))

β2T=−2.98

(Values related to conditional expression (4))

βLT=0.66

βLT: Magnification of lens group (fourth lens group G₇₄) disposed farthest on image side, at telephoto edge
(Values related to conditional expression (5))

|f1|/f2=0.62

(Values related to conditional expression (6))

|f2/f3|=0.43

(Values related to conditional expression (7))

υd1p=31.01

υd1p: Abbe number for d-line of positive lens (positive lens L₇₁₃) included in first lens group G₇₁
(Values related to conditional expression (8))

υd1n=63.86

υd1n: Abbe number for d-line of negative lens (negative lens L₇₁₄) included in first lens group G₁₁
(Values related to conditional expression (9))

υd2pa=88.33

υd2pa: Average value of Abbe number for d-line of positive lenses included in second lens group G₇₂
(Values related to conditional expression (10))

(R31+R32)/(R31−R32)=0.00

R31: Radius of curvature of surface on object side of negative lens L₇₃₁ disposed farthest on object side of third lens group G₇₃
R32: Radius of curvature of surface on image side of negative lens L₇₃₁ disposed farthest on object side of third lens group G₇₃
(Values related to conditional expression (11))

|X2|²/(|f1|×f2)=14.68

X2: Distance that second lens group G₇₂ is moved during zooming from wide angle edge to telephoto edge (=44.07)
(Values related to conditional expression (12))

f2/fLw=0.62

fLw: Composite focal length of third lens group G₇₃ and all lens groups disposed thereafter, at wide angle edge

(=23.70)

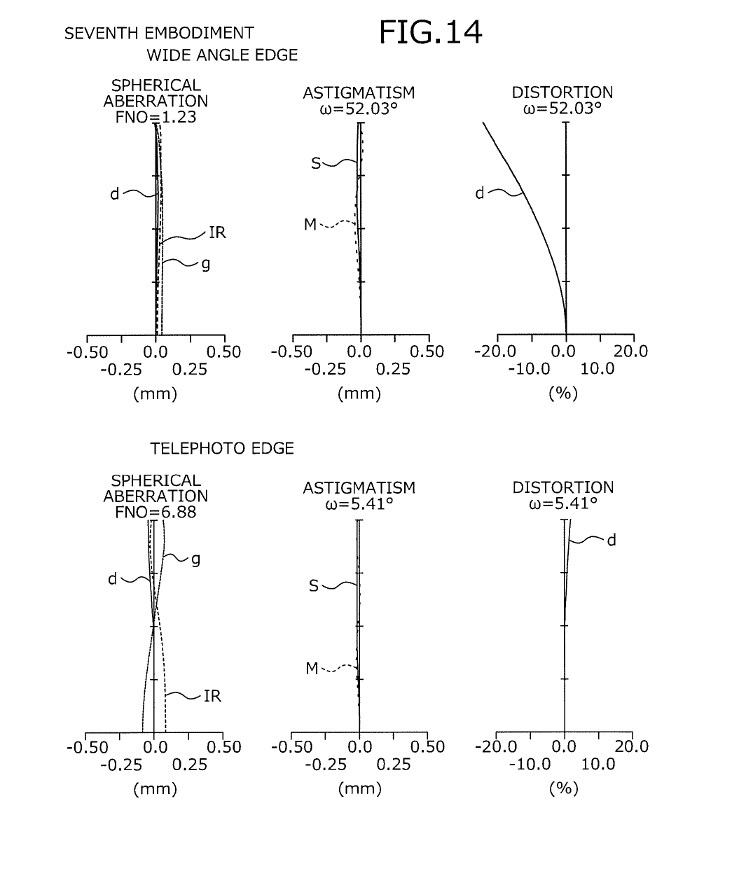

FIG. 14 is a diagram of various types of aberration occurring in the zoom lens according to the seventh embodiment. In the diagram, for curves depicting spherical aberration, the vertical axis represents the F number (FNO), solid lines depict wavelength characteristics corresponding to the d-line (λ=587.56 nm), dotted lines depict wavelength characteristics corresponding to the g-line (λ=435.84 nm), and dashed lines depict wavelength characteristics corresponding to IR rays (λ=850.00 nm). For curves depicting astigmatism, the vertical axis represents the half angle of view (ω) and wavelength characteristics corresponding to d-line are depicted, where solid lines depict characteristics of the sagittal plane (S), and dashed lines depict characteristics of the meridonal plane (M). For curves depicting distortion, the vertical axis represents the half angle of view (ω), and wavelength characteristics corresponding to d-line are depicted.

Among the values for each of the embodiments, r₁, r₂, . . . indicate the radius of curvature of lens surfaces, aperture surface, etc.; d₁, d₂, . . . indicate the thickness of the lenses, the aperture, etc. or the interval between the surfaces thereof; nd₁, nd₂, . . . indicate the refractive index of the lenses with respect to the d-line (λ=546.074 nm); and υd₁, υd₂, . . . indicate the Abbe number for the d-line (λ=587.56 nm) of the lenses. Lengths are indicated in units of “mm”; and angles are indicated in “degrees”.

Each aspheric surface shape above is expressed by the equation below; where, H is the height from the optical axis; X is displacement along the direction of the optical axis, at H when the apex of the lens surface is regarded as the origin; R is paraxial radius of curvature; k is the constant of the cone; A, B, C, D, E are respectively second order, fourth order, sixth order, eighth order, and tenth order aspheric coefficients; and the travel direction of light is assumed to be positive.

$$X ( H ) = \frac{\frac{{H}^{2}}{{R}^{2}}}{1 + \sqrt{1 - ( 1 + k ) ( \frac{{H}^{2}}{{R}^{2}} )}} + {AH}^{2} + {BH}^{4} + {CH}^{6} + {DH}^{8} + {EH}^{10} \qquad [ 1 ]$$

As illustrated by each of the embodiments, according to the present invention, a compact, large-aperture zoom lens having high optical performance capable of favorably correcting various types of aberration over the entire zoom range can be realized. In particular, satisfying conditional expressions (7), (8), and (9) enables the zoom lens to have high optical performance capable of capturing images in not only the visible light region, but also in the near infrared light region. The zoom lens can further enhance optical performance with the disposal of a lens or cemented lens having a suitably formed aspheric surface.

As described, the zoom lens according to the present invention is useful with respect to compact imaging apparatuses equipped with a solid-state image sensing device such as a CCD, CMOS, etc. and is particularly suitable for imaging apparatuses from which high optical performance is demanded.

Further, according to the present invention, image plane variation during zooming and focusing can be suppressed, whereby favorable optical performance can be maintained.

According to the present invention, chromatic difference of magnification occurring at the second lens group with respect to light from the visible light region to the near infrared region is favorably corrected, enabling high optical performance to be obtained.

According to the present invention, various types of aberration occurring at the first lens group can be suppressed.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

This application is based upon and claims the benefit of priority of the prior Japanese Patent Application No. 2014-265327, filed on Dec. 26, 2014, the entire contents of which are incorporated herein by reference.

What is claimed is:

1. A zoom lens comprising sequentially from an object side:
a first lens group having a negative refractive power;
a second lens group having a positive refractive power; and
a third lens group, wherein
the zoom lens performs zooming by varying intervals of the first lens group, the second lens group, and the third lens group on an optical axis,
the second lens group is configured to include sequentially from the object side, a positive lens, a negative lens, and a positive lens,
the third lens group is configured to include a negative lens farthest on the object side, and
the zoom lens satisfies a condition expression (1) 2.8≦|β2T/β2W|≦12.0, where β2T represents magnification of the second lens group at a telephoto edge, and β2W represents magnification of the second lens group at a wide angle edge.

2. The zoom lens according to claim 1, wherein
the first lens group is moved along the optical axis to perform zooming,
the second lens group and a subsequent lens group are moved along the optical axis to correct image plane variation accompanying zooming,
the first lens group is moved along the optical axis, toward the object side to perform focusing from a focused state at infinity to a focused state at a minimum object distance.

3. The zoom lens according to claim 1, wherein
the zoom lens satisfies a conditional expression (2) −0.5≦β2W−0.1, where β2W represents magnification of the second lens group at the wide angle edge.

4. The zoom lens according to claim 1, wherein
the zoom lens satisfies a conditional expression (3) −4.50≦β2T−1.45, where β2T represents magnification of the second lens group at the telephoto edge.

5. The zoom lens according to claim 1, wherein
the zoom lens satisfies a conditional expression (4) 0.3≦βLT≦1.0, where βLT represents magnification of a lens group disposed farthest on the image side, at the telephoto edge.

6. The zoom lens according to claim 1, wherein
an aperture stop that prescribes a given aperture is provided in the second lens group,
the aperture stop moves together with the second lens group, from the image side toward the object side during zooming from the wide angle edge to the telephoto edge.

7. The zoom lens according to claim 1, wherein
the zoom lens satisfies a conditional expression (5) 0.35≦|f1|/f2≦0.85, where f1 represents a focal length of the first lens group and f2 represents a focal length of the second lens group.

8. The zoom lens according to claim 1, wherein
the zoom lens satisfies a conditional expression (6) 0.2≦|f2/f3|≦1.0, where f2 represents a focal length of the second lens group and f3 represents a focal length of the third lens group.

9. The zoom lens according to claim 1, wherein
the first lens group is configured to include at least one positive lens and one negative lens, and
the zoom lens satisfies a conditional expression (7) υd1p≦41.0 and a conditional expression (8) υd1n≧50.0, where υd1p represents an Abbe number for d-line of the positive lens included in the first lens group and υd1n represents an Abbe number for d-line of the negative lens included in the first lens group.

10. The zoom lens according to claim 1, wherein
the zoom lens satisfies a conditional expression (9) υd2pa≧68.0, where υd2pa represents an average value of an Abbe number for d-line of the positive lenses included in second lens group.

11. The zoom lens according to claim 1, wherein
the first lens group is configured to include sequentially from the object side, a negative lens, a negative lens, and a positive lens.

12. The zoom lens according to claim 1, wherein
the third lens group is configured to include sequentially from the object side, a negative lens and a positive lens.

13. The zoom lens according to claim 1, wherein
a negative lens disposed farthest on the object side of the third lens group has a concave surface on the object side, and
the zoom lens satisfies a conditional expression (10) −1.5≦(R31+R32)/(R31−R32)≦0.3, where R31 represents radius of curvature of the concave surface of the negative lens disposed farthest on the object side of the third lens group and R32 represents radius of curvature of a surface on an image side of the negative lens disposed farthest on the object side of the third lens group.

14. The zoom lens according to claim 1, wherein
the zoom lens satisfies a conditional expression (11) 4.5≦|X2|²/(|f1|×f2)≦16.5, where X2 represents a distance that the second lens group is moved during zooming from the wide angle edge to the telephoto edge, f1 represents a focal length of the first lens group and f2 represents a focal length of the second lens group.

15. The zoom lens according to claim 1, wherein
the zoom lens satisfies a conditional expression (12) 0.3≦f2/fLw≦1.1, where f2 represents a focal length of the second lens group and fLw represents a composite focal length of the third lens group and all lens groups disposed thereafter, at the wide angle edge.
